(19) United States
(12) Patent Application Publication
(10) Pub. No.: US 2009/0100677 A1
(43) Pub. Date: Apr. 23, 2009

(54) IMPRINTING METHOD, INFORMATION RECORDING MEDIUM MANUFACTURING METHOD, AND IMPRINTING SYSTEM

(75) Inventors: Minoru FUJITA, Tokyo (JP); Shigeki ISHIYAMA, Tokyo (JP); Satoru KUROKAWA, Tokyo (JP); Hiroaki TAKAHATA, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 12/253,318

(22) Filed: Oct. 17, 2008

(30) Foreign Application Priority Data
Oct. 23, 2007 (JP) 2007-275258
Jul. 24, 2008 (JP) 2008-190975

(51) Int. Cl. B21D 53/76; B29C 59/02

(52) U.S. Cl. 29/890.1; 264/293; 425/343

(57) ABSTRACT

An imprinting method which is capable of forming desired concave/convex patterns on opposite surfaces of a substrate with high accuracy while making it possible to easily peel both stampers off the substrate after completion of a pressing process. As one stamper formed with one concave/convex pattern and the other stamper formed with the other concave/convex pattern for transferring the respective patterns to opposite surfaces of a substrate, there used are one stamper and the other stamper which have similar shapes in plan view and plane areas larger than that of the substrate. The one and the other stampers are pressed against opposite surfaces of the substrate, respectively, such that at least part of an outer periphery of one of the two stampers does not overlap the other in a direction of a thickness of the substrate.

### BACKGROUND OF THE INVENTION

1. Field of the Invention

The present invention relates to an imprinting method of forming concave/convex patterns on opposite surfaces of a substrate using a pair of stampers, a method of manufacturing an information recording medium by forming concave/convex patterns according to the imprinting method, and an imprinting system.

2. Description of the Related Art

As an imprinting method, an information recording medium manufacturing method, and an imprinting system of this kind, Published Japanese Translation of PCT Application No. 2005-537656 discloses an imprinting method and apparatus (hereinafter also referred to as “the imprinting apparatus”) for forming concave/convex patterns on a first surface and a second surface of an object by using a first stamp and a second stamp. In this case, the first stamp is formed with a first pattern having an inverted concave/convex positional relationship with respect to a concave/convex pattern that is to be formed on the first surface of the object, and is configured so as to have a plane area approximately equal to that of the object (diameter approximately equal to that of the object). Further, the second stamp is formed with a second pattern having an inverted concave/convex positional relationship with respect to a concave/convex pattern that is to be formed on the second surface of the object, and is configured so as to have a plane area approximately equal to those of the object and the first stamp (diameter approximately equal to those of the object and the first stamp).

In the above imprinting method, first, the first stamp is disposed on a first contact means of the imprinting apparatus with a surface of the first stamp formed with the first pattern facing upward, and the second stamp is disposed on a second contact means of the imprinting apparatus with a surface of the second stamp formed with the second pattern facing downward. Then, after the object is disposed between the first and second stamps in a manner sandwiched therebetween, the first contact means is moved upward toward the second contact means by pressing means. In doing this, the first pattern of the first stamp is pressed against the first surface of the object, and the second pattern of the second stamp is pressed against the second surface of the object. Thus, the first pattern is transferred to the first surface of the object, whereby a concave/convex pattern having an inverted concave/convex positional relationship with respect to the first pattern is formed on the first surface, and the second pattern is transferred to the second surface of the object, whereby a concave/convex pattern having an inverted concave/convex positional relationship with respect to the second pattern is formed on the second surface.

### SUMMARY OF THE INVENTION

From the study of the above-described conventional imprinting method, the present inventors found the following problems: In the conventional imprinting method, the first stamp and the second stamp are used which have approximately the same plane areas as that of the object and are approximately equal to each other, to thereby form the concave/convex patterns on the first and second surfaces of the object, respectively. Therefore, in a state in which the first and second stamps have been pressed against the object, e.g., outer peripheries of the stamps coincide with an outer periphery of the object in the direction of the thickness of the object (the outer peripheries of the stamps and the object are caused to overlap each other). This makes it difficult for the conventional imprinting method to cause a peeling tool or the like for a peeling process to catch the outer peripheries of the first and second stamps in the state in which the stamps have been pressed against the object. Therefore, the conventional imprinting method suffers from the problem that it is very difficult to peel the stamps off the object.

On the other hand, to solve the above problem, as shown in FIG. 27, the present inventors tried an imprinting method that uses stampers 50Ax and 50Bx diameters L2x and L3x of which are larger than a diameter L1x of a preform 70x (component element corresponding to the “object” in the conventional imprinting method, and a “substrate” in the present invention). If the above stampers 50Ax and 50Bx are used, it is possible to cause outer peripheries of the stampers 50Ax and 50Bx to extend beyond the preform 70x by a length L4x in a state in which the stampers 50Ax and 50Bx have been pressed against a first surface 70ax (one surface thereof toward the stamper 50Ax) and a second surface 70bx (one surface thereof toward the stamper 50Bx) of the preform 70x, respectively, so that there is a possibility that the stampers 50Ax and 50Bx can be easily peeled off the preform 70x e.g., by causing a peeling tool for a peeling process to catch on the outer peripheries of the stampers 50Ax and 50Bx.

More specifically, as shown in FIG. 28, first, the preform 70x is disposed on a fixed base 21x of a stamper attaching device 2X with the first surface 70ax facing upward, and the stamper 50Ax is disposed on a movable base 22x of the stamper attaching device 2X in a manner held by a holding portion 24x, with a surface of the stamper 50Ax formed with a concave/convex pattern (“the first pattern” in the conventional imprinting method) facing downward. Then, the movable base 22x is moved downward toward the fixed base 21x in a direction indicated by an arrow D in FIG. 28. In doing this, as shown in FIG. 29, the surface of the stamper 50Ax formed with the concave/convex pattern is brought into contact with the first surface 70ax of the preform 70x on the fixed base 21x, and the movable base 22x is moved further downward, whereby the stamper 50Ax is brought into intimate contact with the first surface 70ax of the preform 70x (the stamper 50Ax is mounted on the preform 70x).

Subsequently, after the movable base 22x is moved upward in a direction indicated by an arrow U, the stamper 50Ax and the preform 70x are removed from the stamper attaching device 2X, and as shown in FIG. 30, the stamper 50Ax is disposed on a movable base 42x of a pressing device 4X in a manner held by a holding portion 44x, with the second surface 70bx of the preform 70x facing downward. Then, the stamper 50Bx is disposed on a fixed base 41x of the pressing device 4X with a surface of the stamper 50Bx formed with a concave/convex pattern (the “second pattern” in the conventional imprinting method) facing upward. Then, the movable base 42x is moved downward toward the fixed base 41x in a direction indicated by an arrow D in FIG. 30. In doing this, the second surface 70bx of the preform 70x is brought into contact with the surface formed with the concave/convex pattern of the stamper 50Bx on the fixed base 41x, and the movable base 42x is moved further downward, whereby the stamper 50Ax is pressed against the first surface 70ax of the preform 70x to transfer the concave/convex pattern of the stamper 50Ax to the first surface 70ax, and the stamper 50Bx is pressed against the second surface 70bx of the preform 70x to transfer the concave/convex pattern of the stamper 50Bx to the second surface 70bx.

However, in the imprinting method tried by the present inventors, as shown in FIG. 31, when the stampers 50Ax and 50Bx are pressed against the first surface 70ax and the second surface 70bx of the preform 70x by using the pressing device 4X, there is a risk that a foremost end of the holding portion 44x is brought into contact with an outer periphery of the stamper 50Bx on the fixed base 41x depending on a thickness Tx of a holding end of the holding portion 44x which holds the stamper 50Ax. More specifically, when the thickness Tx of the holding end of the holding portion 44x is approximately equal to a thickness T70x of the preform 70x, or when as shown in FIG. 31, when the thickness Tx is larger than the thickness T70x, the foremost end of the holding portion 44x is brought into contact with the outer periphery of the stamper 50Bx. In such a state, even if the movable base 42x is moved further downward toward the fixed base 41x, the stamper 50Bx cannot be brought into contact with the second surface 70bx of the preform 70x due to the holding portion 44x brought into abutment with the stamper 50Bx. As a consequence, there is a risk that the stamper 50Ax is not sufficiently pressed against the first surface 70ax of the preform 70x, or the stamper 50Bx is not sufficiently pressed against the second surface 70bx of the preform 70x.

In this case, it is envisaged to make the thickness Tx of the holding end of the above-described holding portion 44x sufficiently smaller than the thickness T70x of the preform 70x, such that the holding portion 44x is prevented from being brought into abutment with the stamper 50Bx when the movable base 42x is moved downward toward the fixed base 41x. However, there is a risk that when the thickness Tx of the holding end of the holding portion 44x is made smaller, it is difficult to reliably hold the stamper 50Ax, which can cause displacement of the stamper 50Ax with respect to the movable base 42x, and in a worst case, the stamper 50Ax may come off from the movable base 42x. Therefore, when the above configuration where the thickness Tx is made smaller is employed, there is a risk that it becomes difficult to transfer concave/convex patterns with high accuracy.

The present invention has been made in view of these problems, and a main object of the present invention is to provide an imprinting method, an information recording medium manufacturing method, and an imprinting system, which are capable of forming desired concave/convex patterns on opposite surfaces of a substrate with high accuracy while making it possible to easily peel both stampers from the substrate after completion of a pressing process.

To attain the above main object, an imprinting method according to the present invention in which an A stamper formed with an A concave/convex pattern is pressed against one surface of a substrate to thereby transfer the A concave/convex pattern to the one surface, and a B stamper formed with a B concave/convex pattern is pressed against the other surface of the substrate to thereby transfer the B concave/convex pattern to the other surface, whereby a C concave/convex pattern having an inverted concave/convex positional relationship with respect to the A concave/convex pattern is formed on the one surface of the substrate, and a D concave/convex pattern having an inverted concave/convex positional relationship with respect to the B concave/convex pattern is formed on the other surface of the substrate, an A1 stamper and a B1 stamper which have similar shapes in plan view and plane areas larger than that of the substrate are used as the A stamper and the B stamper, and the A1 stamper and the B1 stamper are pressed against opposite surfaces of the substrate, respectively, such that at least part (part or a whole area) of an outer periphery of one of the A1 stamper and the B1 stamper does not overlap the other in a direction of a thickness of the substrate.

It should be noted that throughout the present specification, the term “shape in plan view” is intended to mean a shape of a stamper viewed from a direction orthogonal to a surface of the stamper formed with the A concave/convex pattern or the B concave/convex pattern. Further, throughout the present specification, it is assumed that the term “similar (similar shape)” does not include “congruent (congruent shape)”. Therefore, the A1 stamper and the B1 stamper which have similar shapes in plan view have plane areas different from each other. Furthermore, throughout the present specification, the term “plane area” is intended to mean a “plane area of projection” of a stamper as viewed from a direction orthogonal to a surface of the stamper formed with the A concave/convex pattern or the B concave/convex pattern.

Also, an imprinting method according to the present invention in which an A stamper formed with an A concave/convex pattern is pressed against one surface of a substrate to thereby transfer the A concave/convex pattern to the one surface, and a B stamper formed with a B concave/convex pattern is pressed against the other surface of the substrate to thereby transfer the B concave/convex pattern to the other surface, whereby a C concave/convex pattern having an inverted concave/convex positional relationship with respect to the A concave/convex pattern is formed on the one surface of the substrate, and a D concave/convex pattern having an inverted concave/convex positional relationship with respect to the B concave/convex pattern is formed on the other surface of the substrate, an A2 stamper and a B2 stamper which have different shapes in plan view and plane areas larger than that of the substrate are used as the A stamper and the B stamper, and the A2 stamper and the B2 stamper are pressed against opposite surfaces of the substrate, respectively, such that at least part (part or a whole area) of an outer periphery of one of the A2 stamper and the B2 stamper does not overlap the other in a direction of a thickness of the substrate. It should be noted that throughout the present specification, it is assumed that the stampers which have “different shapes in plan view” do not include stampers which have “similar shapes in plan view”.

Also, an imprinting method according to the present invention in which an A stamper formed with an A concave/convex pattern is pressed against one surface of a substrate to thereby transfer the A concave/convex pattern to the one surface, and a B stamper formed with a B concave/convex pattern is pressed against the other surface of the substrate to thereby transfer the B concave/convex pattern to the other surface, whereby a C concave/convex pattern having an inverted concave/convex positional relationship with respect to the A concave/convex pattern is formed on the one surface of the substrate, and a D concave/convex pattern having an inverted concave/convex positional relationship with respect to the B concave/convex pattern is formed on the other surface of the substrate, an A3 stamper and a B3 stamper which have congruent shapes in plan view and plane areas larger than that of the substrate are used as the A stamper and the B stamper, and the A3 stamper and the B3 stamper are pressed against opposite surfaces of the substrate, respectively, such that part of an outer periphery of one of the A3 stamper and the B3 stamper does not overlap the other in a direction of a thickness of the substrate.

Also, a method of manufacturing an information recording medium according to the present invention, the C concave/convex pattern is formed on the one surface of the substrate, and the D concave/convex pattern is formed on the other surface of the substrate, according to any one of the imprinting methods recited above, and an information recording medium is manufactured using the formed C concave/convex pattern and the formed D concave/convex pattern.

Also, an imprinting system according to the present invention is configured to be capable of forming the C concave/convex pattern on the one surface of the substrate, and forming the D concave/convex pattern on the other surface of the substrate, according to any one of the imprinting methods recited above.

According to these imprinting methods, this information recording medium manufacturing method, and this imprinting system, in a state in which a pressing process is completed, it is possible to cause an outer periphery of the other stamper to extend beyond the substrate and cause an outer periphery of the one stamper to extend beyond the other stamper. This makes it possible to easily peel the stampers off the substrate e.g., by causing a peeling tool to catch the outer peripheries of the stampers, or by pressing the outer peripheries by bringing pin members into abutment therewith. Further, according to the imprinting methods, the information recording medium manufacturing method, and the imprinting system, by holding a portion of one stamper extending beyond the other stamper, it is possible to prevent a holding portion that holds the one stamper from being brought into contact with the other stamper and the substrate, e.g., during the pressing process. This makes it possible to reliably press the stampers against the opposite surfaces of the substrate, to thereby form desired concave/convex patterns with high accuracy.

Further, in the imprinting methods according to the present invention, an A stamper attaching process in which the substrate is disposed on a first lower base with the one surface thereof facing upward, and the A stamper is disposed on a first upper base with a surface thereof formed with the A concave/convex pattern facing downward, whereafter the first upper base is caused to approach relative to the first lower base, to thereby attach the A stamper to the one surface of the substrate, a B stamper attaching process in which the A stamper is disposed on a second lower base with the other surface of the substrate having the A stamper attached thereto facing upward, and the B stamper is disposed on a second upper base with a surface thereof formed with the B concave/convex pattern facing downward, whereafter the second upper base is caused to approach relative to the second lower base, to thereby attach the B stamper to the other surface of the substrate, and a pressing process that presses a laminate of the A stamper, the substrate, and the B stamper by using a pressing device having a third lower base and a third upper base, to thereby form the C concave/convex pattern and the D concave/convex pattern on the substrate are carried out in the mentioned order.

In the method of manufacturing an information recording medium according to the present invention, the C concave/convex pattern is formed on the one surface of the substrate, and the D concave/convex pattern is formed on the other surface of the substrate, according to this imprinting method, and the information recording medium is manufactured using the formed C concave/convex pattern and the formed D concave/convex pattern.

The imprinting system according to the present invention comprises an A stamper attaching device which includes a first lower base on which the substrate can be disposed with the one surface thereof facing upward, and a first upper base on which the A stamper can be disposed with a surface thereof formed with the A concave/convex pattern facing downward, and is configured to be capable of attaching the A stamper to the one surface of the substrate by causing the first upper base to approach relative to the first lower base, a B stamper attaching device which includes a second lower base on which the A stamper can be disposed with the other surface of the substrate having the A stamper attached thereto facing upward, and a second upper base on which the B stamper can be disposed with a surface thereof formed with the B concave/convex pattern facing downward, and is configured to be capable of attaching the B stamper to the other surface of the substrate by causing the second upper base to approach relative to the second lower base, and a pressing device which includes a third lower base and a third upper base, and presses a laminate of the A stamper, the substrate, and the B stamper to thereby form the C concave/convex pattern and the D concave/convex pattern on the substrate.

According to this imprinting method, this information recording medium manufacturing method, and this imprinting system, a direction in which the first upper base is caused to approach relative to the first lower base in the A stamper attaching process, and a direction in which the second upper base is caused to approach relative to the second lower base in the B stamper attaching process can coincide with each other. This makes it possible to carry out the imprinting processes by using equipment for the A stamper attaching process, and equipment for the B stamper attaching process, which are of the same kind in respect of a direction in which one base is moved toward the other base and a direction in which the other base is moved away from the one base.

It should be noted that the present disclosure relates to the subject matters included in Japanese Patent Application No. 2007-275258 filed Oct. 23, 2007, and Japanese Patent Application No. 2008-190975 filed Jul. 24, 2008, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a configuration block diagram of an imprinting system;

FIG. 2 is a cross-sectional view of a magnetic disk manufactured by an imprinting method according to the present invention;

FIG. 3 is a cross-sectional view of a preform for manufacturing the FIG. 2 magnetic disk;

FIG. 4 is a cross-sectional view of an A1 stamper (an A2 stamper, an A3 stamper) and a B1 stamper (a B2 stamper, a B3 stamper) for manufacturing the FIG. 2 magnetic disk;

FIG. 5 is a plan view of the FIG. 3 preform, and the FIG. 4 A1 stamper and B1 stamper;

FIG. 6 is a cross-sectional view of a stamper attaching device in a state in which the FIG. 3 preform is disposed on a fixed base, and the A1 stamper is disposed on a movable base;

FIG. 7 is a cross-sectional view of the stamper attaching device in a state in which a surface formed with a concave/convex pattern of the A1 stamper disposed on the movable base is pressed against (a first surface of) the preform disposed on the fixed base, as changed from the FIG. 6 state;

FIG. 8 is a cross-sectional view of a pressing device in a state in which the preform (A1 stamper) is disposed on another fixed base, and the B1 stamper is disposed on another movable base;

FIG. 9 is a cross-sectional view of the pressing device in a state in which a surface formed with a concave/convex pattern of the B1 stamper disposed on the movable base is pressed against (a second surface of) the preform disposed on the fixed base, as changed from the FIG. 8 state;

FIG. 10 is a cross-sectional view of the A1 stamper, the preform, and the B1 stamper in a state in which a pressing process by the pressing device is completed;

FIG. 11 is a cross-sectional view of a peeling device, the A1 stamper, the preform, and the B1 stamper in a state in which the A1 stamper is held by being attracted by respective attracting pads arranged on a base, and the B1 stamper is held by being attracted by respective attracting pads arranged on another base;

FIG. 12 is a cross-sectional view of the peeling device, the A1 stamper, the preform, and the B1 stamper in a state in which the B1 stamper is bent by pressing pin members against an outer periphery of the B1 stamper, as changed from the FIG. 11 state;

FIG. 13 is a configuration block diagram of another imprinting system;

FIG. 14 is a cross-sectional view of another stamper attaching device in a state in which the preform is disposed on another movable base, and the A1 stamper is disposed on another fixed base;

FIG. 15 is a cross-sectional view of the FIG. 14 stamper attaching device in a state in which (the first surface of) the preform disposed on the movable base is pressed against the surface formed with the concave/convex pattern of the A1 stamper disposed on the fixed base as changed from the FIG. 14 state;

FIG. 16 is a cross-sectional view of another stamper attaching device in a state in which the preform (A1 stamper) is disposed on another movable base, and the B1 stamper is disposed on another fixed base;

FIG. 17 is a cross-sectional view of the FIG. 16 stamper attaching device in a state in which (the second surface of) the preform disposed on the movable base is pressed against the surface formed with the concave/convex pattern of the B1 stamper disposed on the fixed base, as changed from the FIG. 16 state;

FIG. 18 is a cross-sectional view of another pressing device in a state performing the pressing process on the A1 stamper, the preform, and the B1 stamper arranged between another fixed base and another movable base;

FIG. 19 is a configuration block diagram of another imprinting system;

FIG. 20 is a cross-sectional view of another stamper attaching device in a state in which the preform is disposed on another fixed base, and the B1 stamper is disposed on another movable base;

FIG. 21 is a cross-sectional view of the FIG. 20 stamper attaching device in a state in which the surface formed with the concave/convex pattern of the B1 stamper disposed on the movable base is pressed against (the second surface of) the preform disposed on the fixed base, as changed from the FIG. 20 state;

FIG. 22 is a cross-sectional view of another pressing device in a state in which the A1 stamper is disposed on another fixed base, and the preform (B1 stamper) is disposed on another movable base;

FIG. 23 is a cross-sectional view of the FIG. 22 pressing device in a state in which (the first surface of) the preform disposed on the movable base is pressed against the surface formed with the concave/convex pattern of the A1 stamper disposed on the fixed base, as changed from the FIG. 22 state;

FIG. 24 is a plan view of the preform, an A2 stamper, and a B2 stamper;

FIG. 25 is a plan view of the preform, another A2 stamper, and another B2 stamper;

FIG. 26 is a plan view of the preform, an A3 stamper, and a B3 stamper;

FIG. 27 is a cross-sectional view of a preform and stampers used in an imprinting method tried by the present inventors;

FIG. 28 is a cross-sectional view of a stamper attaching device in a state in which the preform is disposed on a fixed base, and one of the stampers is disposed on a movable base;

FIG. 29 is a cross-sectional view of the FIG. 28 stamper attaching device in a state in which a surface formed with a concave/convex pattern of the stamper disposed on the movable base is pressed against (a first surface of) the preform disposed on the fixed base, as changed from the FIG. 28 state;

FIG. 30 is a cross-sectional view of another pressing device in a state in which the other stamper is disposed on another fixed base, and the preform (stamper) is disposed on another movable base; and

FIG. 31 is a cross-sectional view of the FIG. 30 pressing device in a state in which the preform disposed on the movable base is about to be pressed against the stamper disposed on the fixed base, from the FIG. 30 state.

### DESCRIPTION OF THE PREFERRED EMBODIMENTS

Now, the best mode of an imprinting method, an information recording medium manufacturing method, and an imprinting system according to the present invention will be described with reference to the accompanying drawings.

First, a description will be given of the construction of an imprinting system 1A for carrying out an imprinting process according to an imprinting method of the present invention with reference to the drawings.

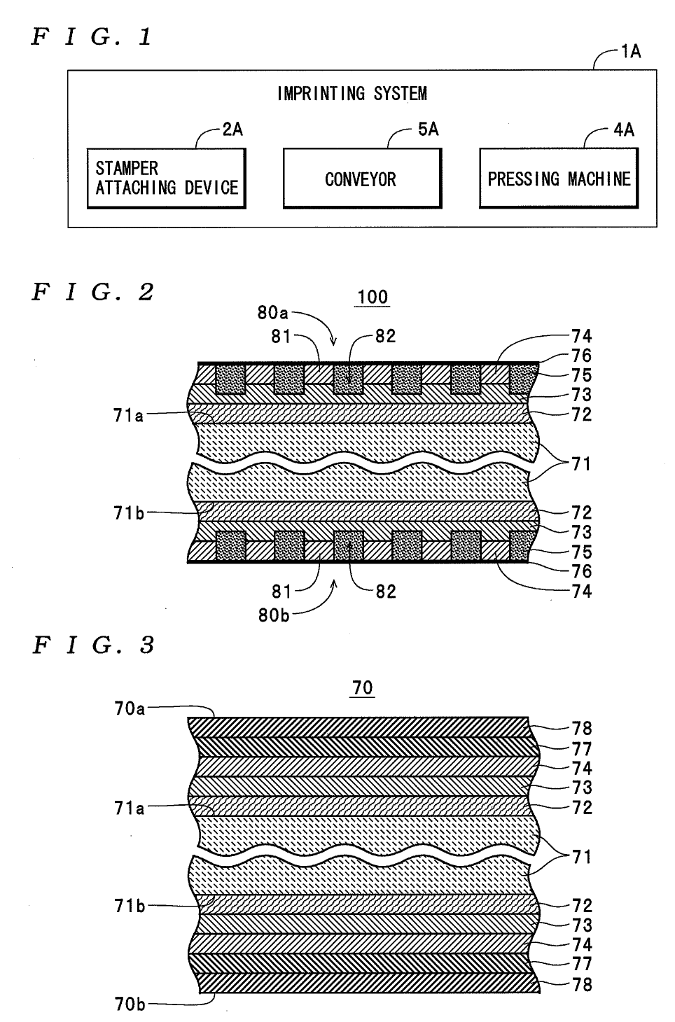

The imprinting system 1A shown in FIG. 1 is an example of an imprinting system according to the present invention, and as described hereinafter, is configured such that it can form an etching mask on a preform 70 (an example of a substrate in the present invention: see FIG. 3) according to the imprinting method of the present invention when manufacturing a magnetic disk 100 (an example of an information recording medium in the present invention: see FIG. 2). In this case, the magnetic disk 100 is a discrete track medium (an example of a patterned medium) which is accommodated in a casing together with a control device, a magnetic head, and a motor, neither of which is shown, to form a hard disk drive. As shown in FIG. 2, the magnetic disk 100 has a soft magnetic layer 72, an intermediate layer 73, and a magnetic layer 74 sequentially formed on each of a first surface 71a and a second surface 71b of a glass base plate 71 in the mentioned order, such that the magnetic disk 100 is capable of recording data e.g., by a perpendicular recording method. It should be noted that FIGS. 2 and 3 illustrate the layers with a different ratio in the magnitude of thickness therebetween from an actual one, for ease of understanding of the present invention.

Further, formed on the magnetic disk 100 are e.g., plural convex portions 81 each having a protruding end made of a magnetic material (magnetic layer 74) and plural concave portions 82 formed between adjacent convex portions 81, thereby forming concave/convex patterns 80a and 80b each of which forms a data track pattern and a servo pattern. Furthermore, a non-magnetic material 75, such as SiO₂, C (carbon), a non-magnetic metal material, or a resin material, is embedded in each of the concave portions 82 of the concave/convex patterns 80a and 80b, whereby the front surface and back surface of the magnetic disk 100 are made smooth. Further, on the magnetic disk 100, a protective layer 76 (DLC layer) is formed e.g., by diamond-like carbon (DLC) in a manner covering the surfaces of the non-magnetic material 75 embedded in the concave portions 82 (embedded between the adjacent convex portions 81 and 81), and the magnetic layer 74 (convex portions 81). The protective layer 76 has a surface coated with lubricant (fluorine-based lubricant, for example) for preventing both the magnetic head and the magnetic disk 100 from being damaged.

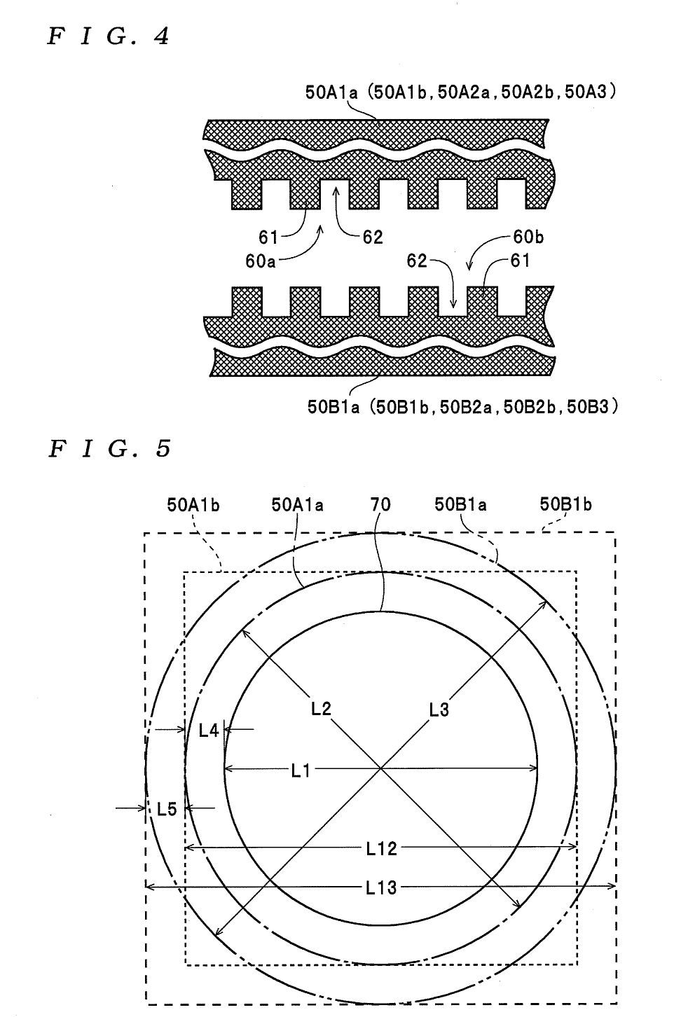

The magnetic disk 100 is manufactured using the preform 70 shown in FIG. 3, and a stamper 50A1a (stamper 50A1b, 50A2a, 50A2b, or 50A3) and a stamper 50B1a (stamper 50B1b, 50B2a, 50B2b, or 50B3) shown in FIG. 4 by an information recording medium manufacturing method according to the present invention, as described hereinafter. As shown in FIG. 3, the preform 70 has the soft magnetic layer 72, the intermediate layer 73, the magnetic layer 74, a B mask layer 77, and an A mask layer 78 sequentially formed on each of the first surface 71a and the second surface 71b of the glass base plate 71 in the mentioned order. The glass base plate 71 is configured to be a disk-shaped substrate which has a thickness of approximately 0.6 mm by polishing the surface of a glass plate. It should be noted that the base plate for use in forming the preform 70 (magnetic disk 100) is not limited to glass base plate, but as the base plate, there may be used any suitable one which is formed e.g., of any of non-magnetic materials, such as aluminum and ceramics, such that it is generally disk-shaped.

The soft magnetic layer 72 is in the form of a thin film having a thickness of approximately 30 nm to 200 nm and is formed by sputtering a soft magnetic material, such as a CoFeNb alloy. The intermediate layer 73, which serves as an underlayer for forming the magnetic layer 74 thereon, is in the form of a thin film having a thickness of approximately 20 nm to 40 nm and is formed by sputtering an intermediate layer forming material, such as Ru, Cr or a CoCr non-magnetic alloy. The magnetic layer 74 is a layer on which the concave/convex pattern 80a or 80b (foremost ends of the convex portions 81) is formed, as described above, and includes the concave portions 82 which are formed to have a depth reaching the intermediate layer 73, by etching a layer formed e.g., by sputtering a CoCrPt alloy such that the layer has a thickness of approximately 10 nm to 30 nm, using the B mask layer 77 as a mask.

The B mask layer 77 serves as the mask for forming the above-described concave portions 82 in the magnetic layer 74 by etching. The B mask layer 77 is in the form of a thin film having a thickness of approximately 10 nm to 30 nm, and is made of a metal material such as Ni or Ta, or C (carbon), for example. The A mask layer 78 is a mask layer used for etching the B mask layer 77 such that the B mask layer 77 is caused to serve as the mask. The A mask layer 78 is e.g., in the form of a thin film having a thickness of approximately 10 nm to 80 nm, and is made of an ultraviolet-curing resin material (e.g., an acrylic resin). In this case, in the preform 70, a C concave/convex pattern and a D concave/convex pattern in the present invention are formed in the respective A mask layers 78 by a transfer process, described hereinafter. It should be noted that in the following description, the surface of the A mask layer 78 formed on the side of the first surface 71a of the glass base plate 71 is referred to as “the first surface 70a” of the preform 70, and the surface of the A mask layer 78 formed on the side of the second surface 71b of the glass base plate 71 is referred to as “the second surface 70b” of the preform 70.

The stamper 50A1a is an example of an A1 stamper in the present invention, and as shown in FIG. 4, is formed with plural convex portions 61 corresponding to the concave portions 82 of the concave/convex pattern 80a of the magnetic disk 100, and plural concave portions 62 corresponding to the convex portions 81 of the concave/convex pattern 80a, such that a concave/convex pattern 60a (an example of an “A concave/convex pattern” in the present invention) having an inverted concave/convex positional relationship with respect to the concave/convex pattern 80a is formed. Further, the stamper 50B1a is an example of a B1 stamper in the present invention, and is formed with plural convex portions 61 corresponding to the concave portions 82 of the concave/convex pattern 80b of the magnetic disk 100, and plural concave portions 62 corresponding to the convex portions 81 of the concave/convex pattern 80b, such that a concave/convex pattern 60b (an example of a “B concave/convex pattern” in the present invention) having an inverted concave/convex positional relationship with respect to the concave/convex pattern 80b is formed.

As shown in FIG. 5, the stampers 50A1a and 50B1a are formed such that they have similar (circular, in the illustrated example) shapes in plan view, but plane areas thereof are different from each other (such that the plane area of the stamper 50B1a becomes larger than that of the stamper 50A1a, in the illustrated example), thereby forming an A stamper and a B stamper, respectively, in the present invention. More specifically, the stamper 50A1a is disk-shaped such that it has a diameter L2 (e.g., 60 mm) larger than the diameter L1 (e.g., 48 mm) of the preform 70, and at the same time smaller than the diameter L3 (e.g., 80 mm) of the stamper 50B1a. Further, the stamper 50B1a is disk-shaped such that the diameter L3 thereof becomes larger than the diameter L1 of the preform 70 and the diameter L2 of the stamper 50A1a. Therefore, the stampers 50A1a and 50B1a are formed such that the plane areas thereof become larger than that of the preform 70, respectively. In this case, the stampers 50A1a and 50B1a are formed, for example, to have a shape of a flat plate having a thickness of approximately 0.6 mm, of a light-transmitting resin material, by injection molding using metal stampers manufactured according to a known method. It should be noted that the method of manufacturing the metal stampers, and the method of manufacturing resin stampers (the stampers 50A1a, 50B1a, etc.) by injection molding are known, and hence detailed description thereof is omitted.

Further, as shown in FIG. 5, the stamper 50A1b is another example of the A1 stamper in the present invention. Similarly to the above-described stamper 50A1a, the stamper 50A1b is formed with the concave/convex pattern 60a corresponding to the A concave/convex pattern in the present invention. Furthermore, the stamper 50B1b is another example the B1 stamper in the present invention. Similarly to the above-described stamper 50B1a, the stamper 50B1b is formed with the concave/convex pattern 60b corresponding to the B concave/convex pattern in the present invention. The stampers 50A1b and 50B1b are formed such that they have similar (square, in the illustrated example) shapes in plan view, but plane areas thereof are different from each other (such that the plane area of the stamper 50B1b becomes larger than that of the stamper 50A1b, in the illustrated example), thereby forming the A stamper and the B stamper in the present invention.

More specifically, the stamper 50A1b is formed to have a shape of a flat plate such that the length L12 (e.g., 60 mm) of each side becomes longer than the diameter L1 (e.g., 48 mm) of the preform 70, and at the same time becomes shorter than the length L13 (e.g., 80 mm) of each side of the stamper 50B1b. Further, the stamper 50B1b is formed to have a shape of a flat plate such that the length L13 of each side becomes longer than the diameter L1 of the preform 70 and the length L12 of each side of the stamper 50A1b. As a consequence, the stampers 50A1b and 50B1b are formed such that the plane areas thereof become larger than that of the preform 70, respectively. It should be noted that in the following description, for ease of understanding of the present invention, an example in which the above-mentioned stampers 50A1a and 50B1a are used will be described. Therefore, if a sequence of operations of a process performed using the stampers 50A1a and 50B1a, described hereinafter, are performed using the stampers 50A1b and 50B1b, it is possible to provide the same advantageous effects as provided by using the stampers 50A1a and 50B1a.

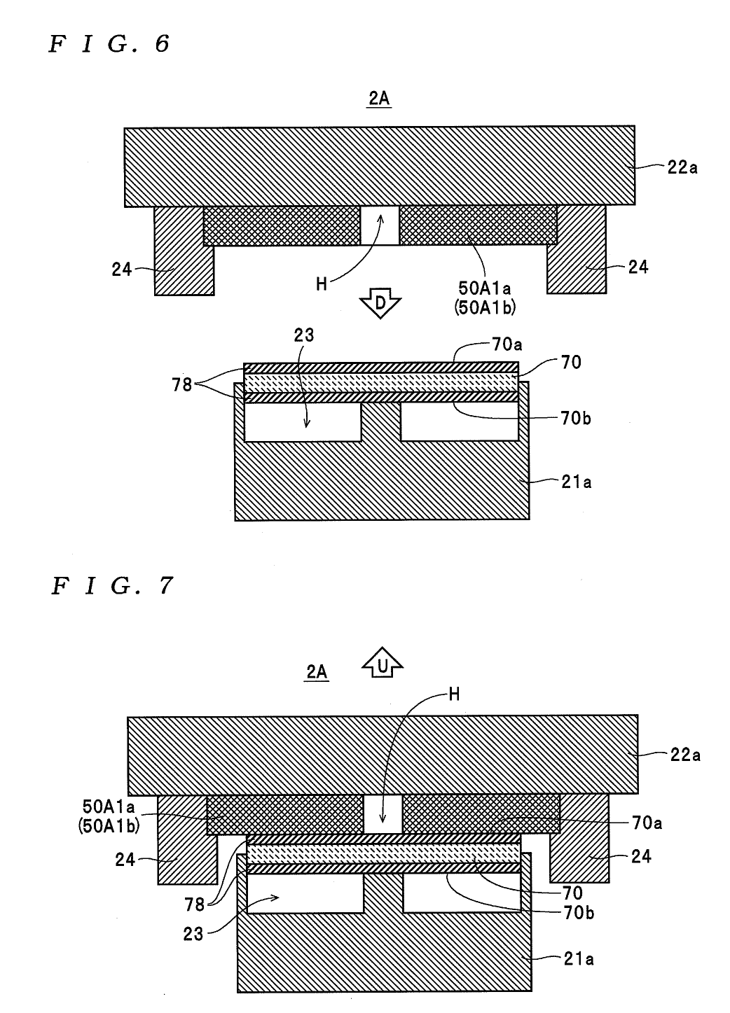

On the other hand, as shown in FIG. 1, the imprinting system 1A is provided with a stamper attaching device 2A, a conveyor 5A, and a pressing device 4A. The stamper attaching device 2A corresponds to an A stamper attaching device in the present invention, and as shown in FIG. 6, is comprised of a fixed base 21a corresponding to a first lower base in the present invention, a movable base 22a corresponding to a first upper base in the present invention, and a vertical movement device (not shown) that vertically moves the movable base 22a with respect to the fixed base 21a.

In this case, the fixed base 21a has an upper surface formed with an annular recess 23 such that when the preform 70 on which the above-described concave/convex patterns 60a and 60b are to be formed is disposed, the preform 70 can be held in a state where the preform 70 is kept from contact with a radially-intermediate area and an outer peripheral area (an area of the second surface 70b of the preform 70 except for a central area (a central hole, not shown, for fitting the preform 70, and an area around the central hole): an area formed with the above-described data track pattern and the servo pattern, in the magnetic disk 100 in a completed state thereof). This causes, as shown in FIG. 6, when the preform 70 is disposed on the fixed base 21a with the first surface 70a facing upward, the preform 70 is held such that the fixed base 21a is brought into contact with the central area of the second surface 70b and the outer periphery of the preform 70 (in a state in which the fixed base 21a is kept from contact with the radially-intermediate area and outer peripheral area of the second surface 70b). Further, the movable base 22a has a lower surface which is formed smooth and has a hollow cylindrical holding portion 24 mounted thereon which has a holding end that can be engaged with an outer periphery of the stamper 50A1a. In this case, the holding end of the holding portion 24 is formed to have a sufficient thickness for reliably holding the stamper 50A1a.

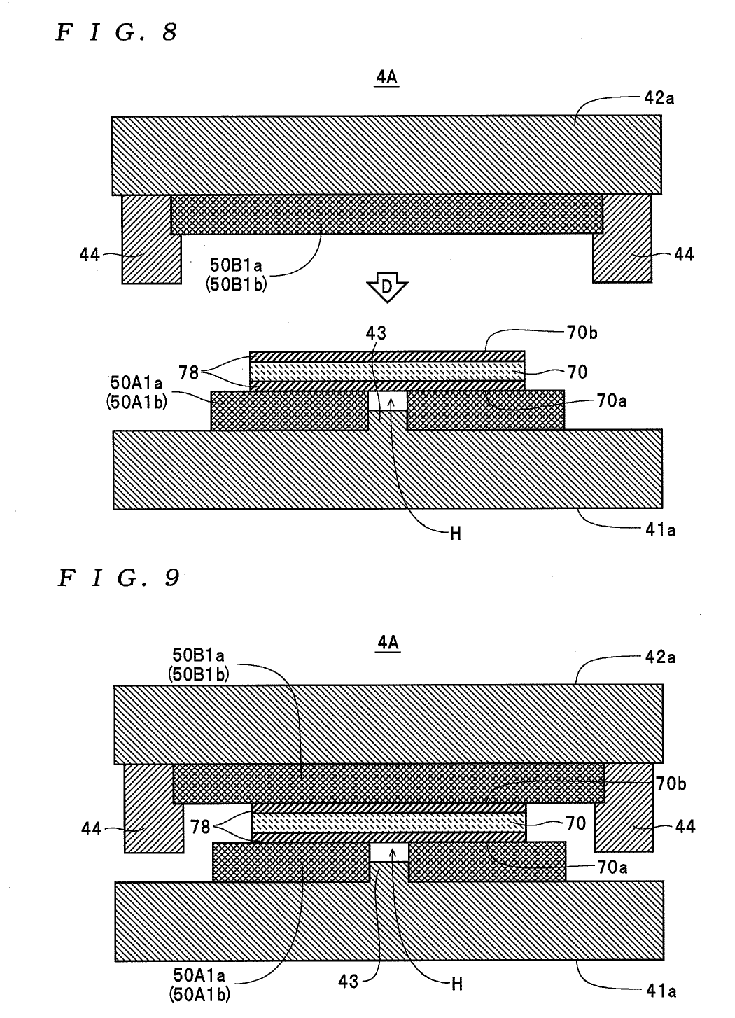

On the other hand, the pressing device 4A corresponds to a B stamper attaching device in the present invention, and a pressing device in the present invention, and as shown in FIG. 8, the pressing device 4A is comprised of a fixed base 41a corresponding to a second lower base and a third lower base in the present invention, a movable base 42a corresponding to a second upper base and a third upper base in the present invention, and a vertical movement device (not shown) that vertically moves the movable base 42a with respect to the fixed base 41a. The fixed base 41a has an upper surface formed with a protrusion 43 which is capable of being fitted into a central hole H of the stamper 50A1a, for positioning the stamper 50A1a at a specified position, when the preform 70 having the stamper 50A1a attached thereto by the stamper attaching device 2A, as described hereinafter, is disposed upside down on the upper surface of the fixed base 41a. In this case, the protrusion 43 is formed such that an outer diameter thereof becomes equal (or approximately equal) to an inner diameter of the central hole H of the stamper 50A1a. Further, the movable base 42a has a lower surface which is formed smooth and has a hollow cylindrical holding portion 44 mounted thereon which has a holding end that can be engaged with an outer periphery of the stamper 50B1a. In this case, the holding end of the holding portion 44 is formed to have a sufficient thickness for reliably holding the stamper 50B1a.

The conveyor 5A conveys the preform 70 having the stamper 50A1a attached thereto by the stamper attaching device 2A to the pressing device 4A. In this case, when the conveyor 5A disposes the conveyed preform 70 (having the stamper 50A1a attached thereto) on the fixed base 41a of the pressing device 4A, as described hereinafter, the conveyor 5A inverts the preform 70 having been removed from the stamper attaching device 2A upside down, and disposes the preform 70 on the fixed base 41a with the stamper 50A1a on a lower side. It should be noted that the imprinting method and the imprinting system according to the present invention are not limited to a method in which the preform 70 is conveyed by the conveyor 5A (a construction including the conveyor 5A), but it is possible to employ e.g., a method in which an operator conveys the preform 70 from the stamper attaching device 2A to the pressing device 4A (a construction without the conveyor 5A).

Next, a description will be given of a method of manufacturing the magnetic disk 100, mainly of the imprinting method executed by the imprinting system 1A.

When the magnetic disk 100 is manufactured, first, the etching mask is formed on the first surface 70a and second surface 70b of the preform 70 by using the above-described stampers 50A1a and 50B1a. More specifically, as shown in FIG. 6, the preform 70 is disposed on the fixed base 21a of the stamper attaching device 2A with the first surface 70a facing upward. In doing this, as described hereinabove, the preform 70 is held such that the fixed base 21a is brought into contact with only the central area and outer periphery of the preform 70. This makes it possible to prevent the fixed base 21a from being brought into contact with the radially-intermediate area and outer peripheral area (area where the data track pattern and the servo pattern are formed later) of the second surface 70b of the preform 70, thereby making it possible to prevent the A mask layer 78 of the second surface 70b from being damaged.

Then, the stamper 50A1a is held (disposed) on the movable base 22a by the holding portion 24 with the surface of the stamper 50A1a formed with the concave/convex pattern 60a facing downward. In doing this, the holding portion 24 holds the outer periphery of the stamper 50A1a (a portion extending beyond the preform 70 when the stamper 50A1a has been attached to the preform 70, as described hereinafter). It is assumed that in a state in which disposition of the preform 70 and the stamper 50A1a is completed, the center of the preform 70 (e.g., the rotation center of the preform 70 when it is used as the magnetic disk 100) and the center of the stamper 50A1a (e.g., the center of the concentric data track pattern formed by the concave/convex pattern 60a) coincide with each other in the direction of the vertical motion of the movable base 22a with respect to the fixed base 21a, by performing the positioning operation.

Subsequently, the movable base 22a is moved downward with respect to the fixed base 21a in a direction indicated by an arrow D in FIG. 6 (an example of a process in which “the first upper base is caused to approach relative to the first lower base” in the present invention), and as shown in FIG. 7, the surface of the stamper 50A1a formed with the concave/convex pattern 60a is pressed against the first surface 70a (A mask layer 78) of the preform 70 on the fixed base 21a. This brings the first surface 70a of the preform 70 and the surface of the stamper 50A1a formed with the concave/convex pattern 60a (a protruding end face of each convex portion 61) into intimate contact with each other, whereby attachment of the stamper 50A1a to the preform 70 (an “A stamper attaching process” in the present invention) is completed.

Then, after the movable base 22a is moved upward in a direction indicated by an arrow U in FIG. 7, the conveyor 5A removes the preform 70 having the stamper 50A1a attached thereto from the stamper attaching device 2A, and conveys the preform 70 to the pressing device 4A. In doing this, the conveyor 5A inverts the preform 70 and the stamper 50A1a removed from the stamper attaching device 2A, upside down, whereby as shown in FIG. 8, the conveyor 5A disposes the preform 70 and the stamper 50A1a on the fixed base 41a of the pressing device 4A, with the second surface 70b of the preform 70 facing upward. In this case, as described above, the fixed base 41a is formed with the protrusion 43 the outer diameter of which is equal to the inner diameter of the central hole H of the stamper 50A1a. Therefore, the stamper 50A1a and the preform 70 are disposed on the fixed base 41a in a manner fitting the protrusion 43 into the central hole H of the stamper 50A1a, whereby the stamper 50A1a and the preform 70 are both positioned with respect to the fixed base 41a.

Next, the stamper 50B1a is held (disposed) on the movable base 42a by the holding portion 44 with the surface of the stamper 50B1a formed with the concave/convex pattern 60b facing downward. In doing this, the holding portion 44 holds the outer periphery of the stamper 50B1a (a portion extending beyond both the preform 70 and the stamper 50A1a in the state in which the stamper 50B1a has been attached to the preform 70, as described hereinafter). It is assumed that in a state in which disposition of the preform 70 (stamper 50A1a) and the stamper 50B1a is completed, the center of the preform 70 (e.g., the rotation center of the preform 70 when it is used as the magnetic disk 100) and the center of the stamper 50B1a (e.g., the center of the concentric data track pattern formed by the concave/convex pattern 60b) coincide with each other in the direction of the vertical motion of the movable base 42a with respect to the fixed base 41a, by performing the positioning operation.

Then, the movable base 42a is moved downward with respect to the fixed base 41a in a direction indicated by an arrow D in FIG. 8 (an example of a process in which “the second upper base is caused to approach relative to the second lower base” in the present invention), and as shown in FIG. 9, the surface of the stamper 50B1a formed with the concave/convex pattern 60b is pressed against the second surface 70b (A mask layer 78) of the preform 70 on the fixed base 41a. This brings the second surface 70b of the preform 70 and the surface of the stamper 50B1a formed with the concave/convex pattern 60b (the protruding end face of each convex portion 61) into intimate contact with each other, whereby attachment of the stamper 50B1a to the preform 70 (a “B stamper attaching process” in the present invention) is completed.

In this case, the diameter L3 of the stamper 50B1a disposed on the movable base 42a is sufficiently larger than the diameter L2 of the stamper 50A1a disposed on the fixed base 41a and the diameter L1 of the preform 70 also disposed on the fixed base 41a, and hence when the “B stamper attaching process” in the present invention is carried out, it is possible to prevent a foremost end of the holding portion 44 which holds the stamper 50B1a, from being brought into abutment with the outer periphery of the stamper 50A1a and that of the preform 70. Further, in the state in which attachment of the stamper 50B1a is completed, the whole area of the outer periphery of the stamper 50B1a (an example of “at least part” in the present invention being a whole area) does not overlap the stamper 50A1a in the direction of the thickness of the preform 70.

Subsequently, the movable base 42a is moved further downward with respect to the fixed base 41a, whereby the pressing device 4A is caused to serve as the pressing device in the present invention (the fixed base 41a is caused to serve as the third lower base in the present invention, and the movable base 42a is caused to serve as the third upper base in the present invention), for pressing the concave/convex pattern 60a of the stamper 50A1a against the first surface 70a of the preform 70, and pressing the concave/convex pattern 60b of the stamper 50B1a attached to the second surface 70b against the second surface 70b. More specifically, as the movable base 42a moves downward with respect to the fixed base 41a, the concave/convex pattern 60a of the stamper 50A1a is pressed against the A mask layer 78 of the first surface 70a of the preform 70, and each convex portion 61 of the concave/convex pattern 60a is pushed into the A mask layer 78 of the first surface 70a, while the concave/convex pattern 60b of the stamper 50B1a is pressed against the A mask layer 78 of the second surface 70b of the preform 70, and each convex portion 61 of the concave/convex pattern 60b is pushed into the A mask layer 78 of the second surface 70b. At this time, the resin material (A mask layer 78) of portions of the A mask layer 78, into which are pushed the convex portions 61 of the concave/convex patterns 60a and 60b, moves into the concave portions 62 of the concave/convex patterns 60a and 60b. This causes the convex portions 61 of the stampers 50A1a and 50B1a to be pushed deep enough into the A mask layers 78 of the first surface 70a and second surface 70b of the preform 70.

Next, both of the A mask layers 78 are cured by irradiation with ultraviolet rays via the stampers 50A1a and 50B1a, while maintaining the state of the stampers 50A1a and 50B1a being pressed against the preform 70. As a consequence, the concave/convex pattern 60a of the stamper 50A1a is transferred to the A mask layer 78 of the first surface 70a of the preform 70, whereby a concave/convex pattern (C concave/convex pattern in the present invention: not shown) having an inverted concave/convex positional relationship with respect to the concave/convex pattern 60a is formed on the A mask layer 78 (one surface in the present invention) of the first surface 70a, and the concave/convex pattern 60b of the stamper 50B1a is transferred to the A mask layer 78 of the second surface 70b of the preform 70, whereby a concave/convex pattern (D concave/convex pattern in the present invention: not shown) having an inverted concave/convex positional relationship with respect to the concave/convex pattern 60b is formed on the A mask layer 78 (the other surface in the present invention) of the second surface 70b. This completes the “pressing process” in the present invention.

It should be noted that although the above description has been given of the example in which the pressing process is started immediately after the stamper 50B1a is attached to the second surface 70b of the preform 70, this is not limitative, but it is also possible to start the pressing process by using e.g., a thermoplastic resin material as a resin material for forming the A mask layers 78, and a pressing device different from the attaching device, (pressing device 4A in the illustrated example) for attaching the stamper 50B1a, after heating the preform 70 and the stampers 50A1a and 50B1a to a predetermined temperature (e.g., a temperature not lower than the glass transition temperature of the A mask layers 78). If such a method is employed, it is possible to smoothly push the convex portions 61 into the A mask layers 78.

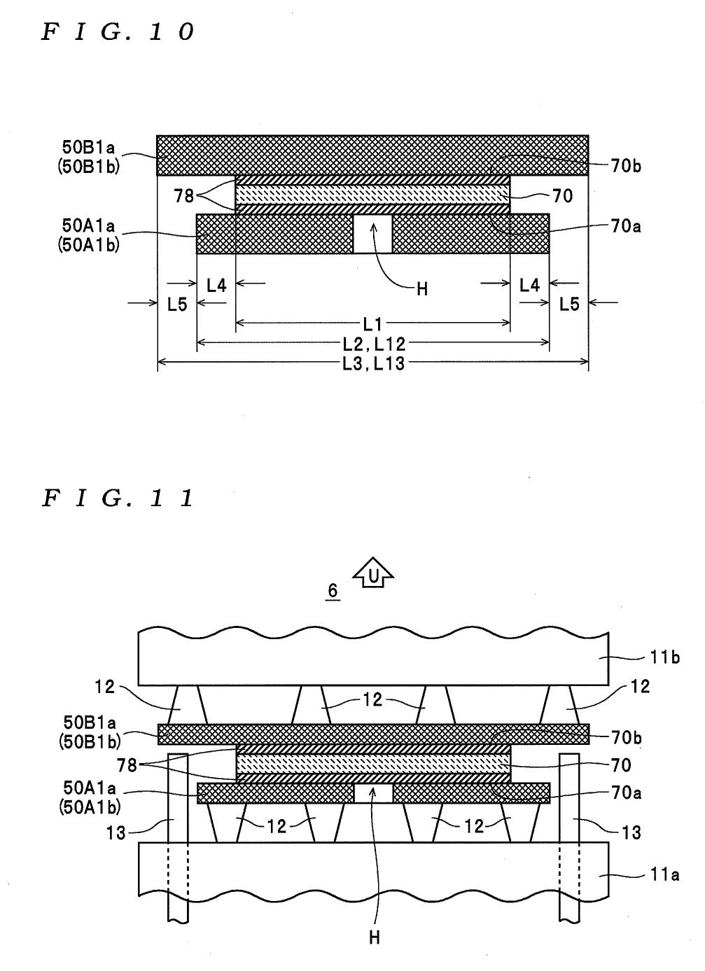

In this case, as shown in FIG. 10, in the state in which the pressing process by the pressing device 4A is completed, the stamper 50A1a is brought into intimate contact with the first surface 70a of the preform 70 in a manner extending beyond the outer periphery of the preform 70 by a length L4, and at the same time the stamper 50B1a is brought into intimate contact with the second surface 70b of the preform 70 in a manner extending beyond the outer periphery of the stamper 50A1a by a length L5. Therefore, unlike the conventional imprinting method (imprinting method which uses a first stamp and a second stamp of which plane areas have approximately the same size as that of an object, and are approximately equal to each other), in which outer peripheries of the two stamps coincide with each other (the outer peripheries of the stamps overlap each other) in the direction of the thickness of the object with respect to an outer periphery of the object in a state in which the stamps have been pressed against the object, it is possible to smoothly peel the stamper 50B1a off the preform 70 (second surface 70b) by causing a peeling tool to catch the outer periphery of the stamper 50B1a extending beyond the stamper 50A1a, and smoothly peel the stamper 50A1a off the preform 70 (first surface 70a) by causing the peeling tool to catch the outer periphery of the stamper 50A1a extending beyond the preform 70.

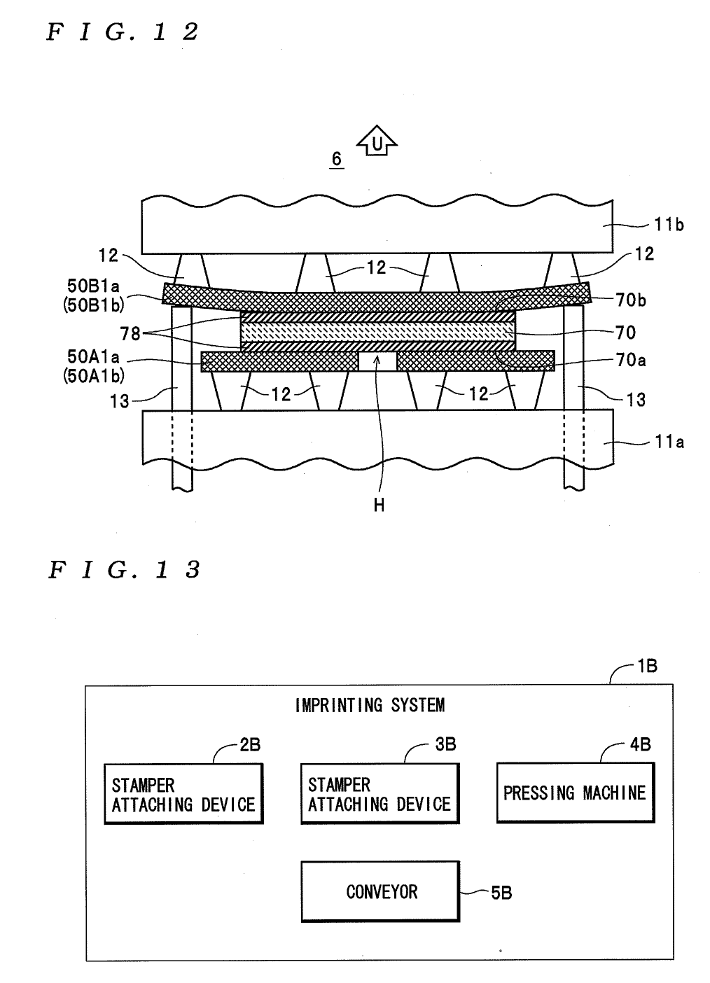

It should be noted that the method of peeling the stampers 50A1a and 50B1a is not limited to the above-described method of peeling the stampers by causing the peeling tool to catch the outer peripheries of the stampers 50A1a and 50B1a. More specifically, to peel the stamper 50B1a, a peeling device 6 illustrated in FIGS. 11 and 12, by way of example, can be used. This peeling device 6 is comprised of a base portion 11a having plural attracting pads 12 arranged thereon, a base portion 11b having plural attracting pads 12 arranged thereon, and plural pin members 13 configured to be capable of moving upward and downward with respect to the base portion 11a. In this case, the attracting pads 12 are connected to an air pump, not shown, and the air pump operates to thereby attract and hold the stampers 50A1a and 50B1a thereon. Further, the peeling device 6 is configured, for example, such that the base portion 11a is fixed to a frame, not shown, and the base portion 11b is moved toward and away from the base portion 11a by a vertical movement mechanism, not shown. Furthermore, each pin member 13 is caused to vertically slide with respect to the base portion 11a by the vertical movement mechanism, not shown.

To peel the stamper 50B1a by the peeling device 6, first, as shown in FIG. 11, in the state in which the pressing process by the pressing device 4A is completed, the laminate of the stamper 50A1a, the preform 70, and the stamper 50B1a is set at a processing position. More specifically, the attracting pads 12 provided in the base portion 11a attract the back surface of the stamper 50A1a to hold the stamper 50A1a, and at the same time the attracting pads 12 provided in the base portion 11b attract the back surface of the stamper 50B1a to hold the stamper 50B1a. Then, each pin member 13 is caused to slide in a direction indicated by an arrow U with respect to the base portion 11a. In doing this, the foremost end of the pin member 13 is brought into abutment with the outer periphery of the stamper 50B1a extending beyond the stamper 50A1a, and in this state, the pin member 13 is caused to slide further upward, whereby as shown in FIG. 12, the stamper 50B1a is bent such that the outer periphery of the stamper 50B1a warps upward.

In this case, the stamper 50A1a is brought into intimate contact with the first surface 70a of the preform 70 in a manner extending beyond the outer periphery of the preform 70 by the length L4, and at the same time the stamper 50B1a is brought into intimate contact with the second surface 70b of the preform 70 in a manner extending beyond the outer periphery of the stamper 50A1a by the length L5. This makes it possible to bring the respective pin members 13 into abutment with the outer periphery of the stamper 50B1a without bringing the pin members 13 into contact with the stamper 50A1a and the preform 70, whereby the stamper 50B1a can be sufficiently bent. This causes, as shown in FIG. 12, the stamper 50B1a to be peeled off from the second surface 70b of the preform 70, at the outer periphery of the preform 70. In this state, by moving the base portion 11b in a direction indicated by an arrow U with respect to the base portion 11a, it is possible to cause the stamper 50B1a to be smoothly peeled off from the second surface 70b of the preform 70, in the whole area of the preform 70, while maintaining the state in which the stamper 50A1a is in intimate contact with the first surface 70a of the preform 70.

Then, the stamper 50A1a is peeled off the preform 70 by a peeling device, not shown. In this case, to peel the stamper 50A1a, a device is used which includes e.g., a base portion that has a holding part disposed therein for holding the preform 70 in a manner holding a peripheral surface thereof in place of the base portion 11a of the above-described peeling device 6. It should be noted that the process for peeling the stamper 50A1a by the above peeling device (method of peeling the stamper 50A1a by bending the stamper using the pin members) is the same as the process (method) for peeling the stamper 50B1a by the above-described peeling device 6, and hence detailed description of the process for peeling the stamper 50A1a, and illustration thereof in figures are omitted. As described hereinabove, by performing the stamper peeling process using the peeling tool, or the stamper peeling process using the peeling device 6 or the like, mask patterns have been formed on both of the A mask layers 78 of the preform 70.

After that, e.g., an oxygen plasma treatment is carried out on the first surface 70a and second surface 70b of the preform 70, which have been subjected to the stamper peeling process, whereby the resin material (residue) remaining on a bottom surface of each concave portion of the concave/convex patterns formed on the A mask layers 78 is removed to cause the B mask layers 77 to be exposed from the A mask layers 78 on the bottom surface of each concave portion of the concave/convex patterns which are formed on the A mask layers 78. Subsequently, both of the B mask layers 77 are etched using the concave/convex patterns (masks) formed on the A mask layers 78, whereby concave/convex patterns (B mask patterns: not shown) made of the B mask layers 77 are formed on the magnetic layers 74, respectively. Then, the first surface 70a and second surface 70b (magnetic layers 74) of the preform 70 are etched by performing the etching process using the B mask patterns as masks, whereby the concave/convex patterns 80a and 80b having the plural convex portions 81 and the plural concave portions 82 are formed on the magnetic layers 74. This forms the data track pattern and the servo pattern on the intermediate layers 73 (not shown).

Next, the B mask layer 77 remaining on each convex portion 81 is selectively removed by the etching process to cause a protruding end face of each convex portion 81 to be exposed. Then, SiO2 as the non-magnetic material 75 is sputtered to thereby cover the surfaces formed with the concave/convex patterns 80a and 80b with the non-magnetic material 75. Then, an ion beam etching process is carried out on the layers of the non-magnetic material 75 on the magnetic layers 74 (on each convex portion 81 and each concave portion 82). In doing this, the ion beam etching process is continued e.g., until the protruding end face of each convex portion 81 is exposed from the non-magnetic material 75. This smoothes the opposite surfaces of the preform 70. Then, thin films of diamond-like carbon (DLC) are formed by a chemical vapor deposition (CVD) method such that the thin films cover the surfaces of the preform, thereby forming the protective layers 76. After that, fluorine-based lubricant is applied to the surfaces of the protective layers 76 such that the average thickness of the applied lubricant is approximately 2 nm, whereby the magnetic disk 100 is completed, as shown in FIG. 2. This completes the information recording medium manufacturing method according to the present invention.

Next, an imprinting method according to another embodiment of the present invention will be described with reference to the drawings. It should be noted that the same component elements as those of the imprinting system 1A, the preform 70, and the stampers 50A1a and 50B1a are denoted by identical reference numerals and duplicate description thereof will be omitted.

Although in the above-described imprinting system 1A, when the A stamper attaching process in the present invention is carried out, the stamper attaching device 2A, which is configured to move the movable base 22a upward and downward with respect to the fixed base 21a, is used as the A stamper attaching device in the present invention, while the pressing device 4A, which is configured to move the movable base 42a upward and downward with respect to the fixed base 41a, is used as the B stamper attaching device in the present invention, and the pressing process in the present invention is carried out using the pressing device 4A, this is not limitative. More specifically, an imprinting system 1B shown in FIG. 13 can be used in place of the imprinting system 1A.

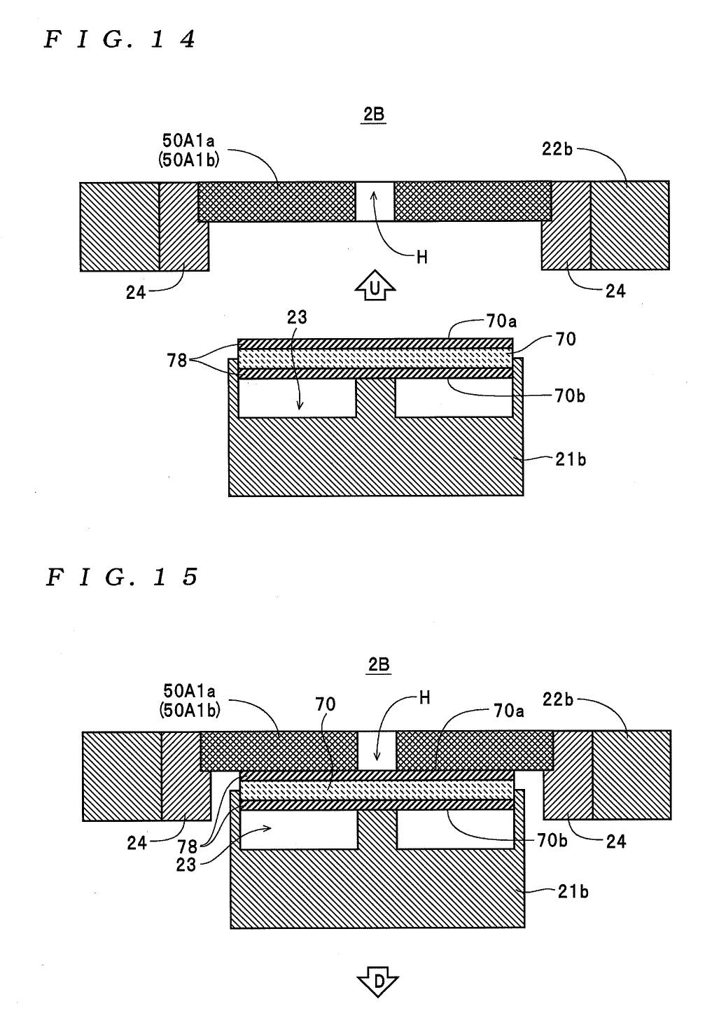

The imprinting system 1B is another example of the imprinting system according to the present invention, and is comprised of a stamper attaching device 2B, a stamper attaching device 3B, a pressing device 4B, and a conveyor 5B. The stamper attaching device 2B is another example of the A stamper attaching device in the present invention, and as shown in FIG. 14, is comprised of a movable base 21b, which is another example of the first lower base in the present invention, a fixed base 22b, which is another example of the first upper base in the present invention, and a vertical movement device (not shown) that vertically moves the movable base 21b with respect to the fixed base 22b. In this case, the annular recess 23 is formed in an upper surface of the movable base 21b, similarly to the fixed base 21a of the stamper attaching device 2A of the above-mentioned imprinting system 1A. Further, the hollow cylindrical holding portion 24 having a holding end which can be engaged with the outer periphery of the stamper 50A1a is mounted to the fixed base 22b. In this case, the holding end of the holding portion 24 is formed to have a sufficient thickness for reliably holding the stamper 50A1a.

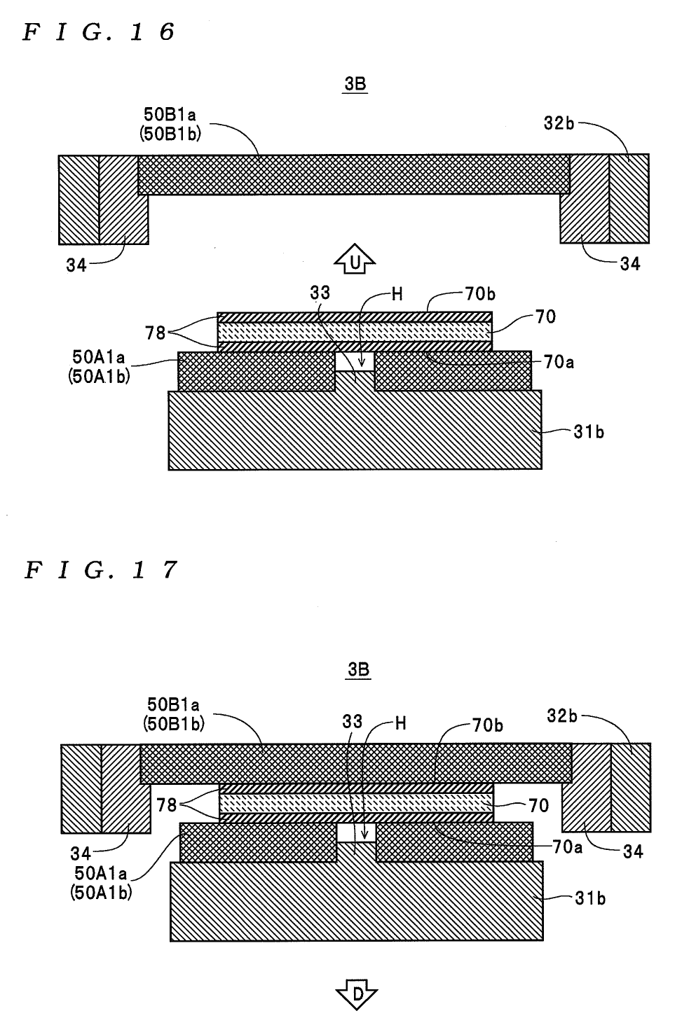

Further, the stamper attaching device 3B is another example of the B stamper attaching device in the present invention, and as shown in FIG. 16, is comprised of a movable base 31b, which is another example of the second lower base in the present invention, a fixed base 32b, which is another example of the second upper base in the present invention, and a vertical movement device (not shown) that vertically moves the movable base 31b with respect to the fixed base 32b. In this case, the movable base 31b has an upper surface formed with a cylindrical protrusion 33 which is similar to the protrusion 43 of the fixed base 41a of the pressing device 4A in the above-described imprinting system 1A. Further, mounted to the fixed base 32b is a hollow cylindrical holding portion 34 having a holding end which can be engaged with the outer periphery of the stamper 50B1a. In this case, the holding end of the holding portion 34 is formed to have a sufficient thickness for reliably holding the stamper 50B1a.

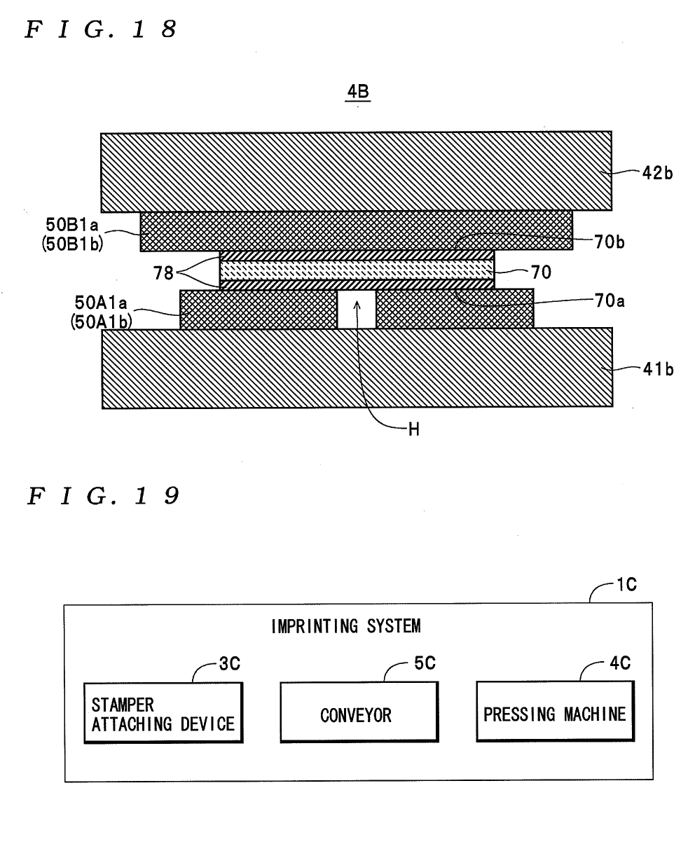

On the other hand, the pressing device 4B is another example of the pressing device in the present invention, and as shown in FIG. 18, is comprised of a fixed base 41b, which is another example of the third lower base in the present invention, a movable base 42b, which is another example of the third upper base in the present invention, and a vertical movement device (not shown) that vertically moves the movable base 42b with respect to the fixed base 41b. The conveyor 5B conveys the preform 70 having the stamper 50A1a attached thereto by the stamper attaching device 2B to the stamper attaching device 3B, and conveys the preform 70 having the stamper 50B1a attached thereto by the stamper attaching device 3B to the pressing device 4B. In this case, as described hereinafter, when the conveyor 5B conveys the preform 70 (having the stamper 50A1a attached thereto) from the stamper attaching device 2B and disposes the same on the movable base 31b of the stamper attaching device 3B, it inverts the preform 70 upside down, and then disposes the preform 70 on the movable base 31b with the stamper 50A1a on a lower side. It should be noted that the imprinting method and the imprinting system according to the present invention are not limited to the method of conveying the preform 70 by the conveyor 5B (a construction including the conveyor 5B), but it is possible to employ e.g., a method in which the operator conveys the preform 70 from the stamper attaching device 2B to the stamper attaching device 3B and conveys the preform 70 from the stamper attaching device 3B to the pressing device 4B (a construction without the conveyor 5B).

Next, a description will be given of another method of manufacturing the magnetic disk 100, mainly of an imprinting method executed by the imprinting system 1B.

First, as shown in FIG. 14, the preform 70 is disposed on the movable base 21b of the stamper attaching device 2B with the first surface 70a of the preform 70 facing upward. In doing this, as described above, the preform 70 is held such that the movable base 21b is brought into contact with only the central area and outer periphery of the preform 70. Then, the stamper 50A1a is held (disposed) on the fixed base 22b by the holding portion 24 with the surface of the stamper 50A1a formed with the concave/convex pattern 60a facing downward. In doing this, the holding portion 24 holds the outer periphery of the stamper 50A1a (the portion extending beyond the preform 70 in the state in which the stamper 50A1a has been attached to the preform 70, as described hereinafter). It is assumed that in a state in which disposition of the preform 70 and the stamper 50A1a is completed, the center of the preform 70 (e.g., the rotation center of the preform 70 when it is used as the magnetic disk 100) and the center of the stamper 50A1a (e.g., the center of the concentric data track pattern formed by the concave/convex pattern 60a) coincide with each other in the direction of the vertical motion of the movable base 21b with respect to the fixed base 22b, by carrying out the positioning operation.

Subsequently, the movable base 21b is moved upward with respect to the fixed base 22b in a direction indicated by an arrow U in FIG. 14 (another example of the process in which “the first upper base is caused to approach relative to the first lower base” in the present invention), and as shown in FIG. 15, the first surface 70a (A mask layer 78) of the preform 70 is pressed against the surface formed with the concave/convex pattern 60a of the stamper 50A1a disposed on the fixed base 22b. This brings the first surface 70a of the preform 70 and the surface of the stamper 50A1a formed with the concave/convex pattern 60a (the protruding end face of each convex portion 61) into intimate contact with each other, whereby attachment of the stamper 50A1a to the preform 70 (the “A stamper attaching process” in the present invention) is completed.

Then, after the movable base 21b is moved downward in a direction indicated by an arrow D in FIG. 15, the conveyor 5B removes the preform 70 having the stamper 50A1a attached thereto from the stamper attaching device 2B, and conveys the preform 70 to the stamper attaching device 3B. In doing this, the conveyor 5B inverts the preform 70 removed from the stamper attaching device 2B and the stamper 50A1a upside down, whereby as shown in FIG. 16, the conveyor 5B disposes the preform 70 and the stamper 50A1a on the movable base 31b of the stamper attaching device 3B, with the second surface 70b of the preform 70 facing upward. In this case, as described hereinabove, the movable base 31b is formed with the protrusion 33 the outer diameter of which is equal to the inner diameter of the central hole H of the stamper 50A1a. Therefore, the stamper 50A1a and the preform 70 are disposed on the movable base 31b in a manner fitting the protrusion 33 into the central hole H of the stamper 50A1a, whereby the stamper 50A1a and the preform 70 are positioned with respect to the movable base 31b.

Next, the stamper 50B1a is held (disposed) on the fixed base 32b by the holding portion 34 with the surface of the stamper 50B1a formed with the concave/convex pattern 60b facing downward. In doing this, the holding portion 34 holds the outer periphery of the stamper 50B1a (the portion extending beyond both the preform 70 and the stamper 50A1a in the state in which the stamper 50B1a has been attached to the preform 70, as described hereinafter). It is assumed that in the state in which disposition of the preform 70 (stamper 50A1a) and the stamper 50B1a is completed, the center of the preform 70 (e.g., the rotation center of the preform 70 when it is used as the magnetic disk 100) and the center of the stamper 50B1a (e.g., the center of the concentric data track pattern formed by the concave/convex pattern 60b) coincide with each other in the direction of the vertical motion of the movable base 31b with respect to the fixed base 32b, by performing the positioning operation.

Then, the movable base 31b is moved upward with respect to the fixed base 32b in a direction indicated by an arrow U in FIG. 16 (another example of the process in which “the second upper base is caused to approach relative to the second lower base” in the present invention), and as shown in FIG. 17, the second surface 70b (A mask layer 78) of the preform 70 on the movable base 31b is pressed against the surface formed with the concave/convex pattern 60b of the stamper 50B1a disposed on the fixed base 32b. This brings the second surface 70b of the preform 70 and the surface of the stamper 50B1a formed with the concave/convex pattern 60b (the protruding end face of each convex portion 61) into intimate contact with each other, whereby attachment of the stamper 50B1a to the preform 70 (the “B stamper attaching process” in the present invention) is completed.

In this case, the diameter L3 of the stamper 50B1a disposed on the fixed base 32b is sufficiently larger than the diameter L2 of the stamper 50A1a disposed on the movable base 31b and the diameter L1 of the preform 70 also disposed on the movable base 31b, and hence when the “B stamper attaching process” in the present invention is carried out, it is possible to prevent a foremost end of the holding portion 34 which holds the stamper 50B1a, from being brought into abutment with the outer periphery of the stamper 50A1a and that of the preform 70. Further, in the state in which the stamper 50B1a has been attached to the preform 70, the whole area of the outer periphery of the stamper 50B1a (an example of “at least part” in the present invention being a whole area) does not overlap the stamper 50A1a in the direction of the thickness of the preform 70.

Then, after the movable base 31b is moved downward in a direction indicated by an arrow D in FIG. 17, the conveyor 5B removes the preform 70 having the stamper 50B1a attached thereto from the stamper attaching device 3B, and conveys the preform 70 to the pressing device 4B, and disposes the preform 70 between the fixed base 41b and the movable base 42b of the pressing device 4B. Subsequently, the movable base 42b is moved downward with respect to the fixed base 41b to thereby press the stamper 50A1a, the preform 70, and the stamper 50B1a sandwiched between the fixed base 41b and the movable base 42b. At this time, the concave/convex pattern 60a of the stamper 50A1a attached to the first surface 70a of the preform 70 is pressed against the first surface 70a, and the concave/convex pattern 60b of the stamper 50B1a attached to the second surface 70b of the preform 70 is pressed against the second surface 70b.

More specifically, as the movable base 42b moves downward with respect to the fixed base 41b, the concave/convex pattern 60a of the stamper 50A1a is pressed against the A mask layer 78 of the first surface 70a of the preform 70, and each convex portion 61 of the concave/convex pattern 60a is pushed into the A mask layer 78 of the first surface 70a, while the concave/convex pattern 60b of the stamper 50B1a is pressed against the A mask layer 78 of the second surface 70b of the preform 70, and each convex portion 61 of the concave/convex pattern 60b is pushed into the A mask layer 78 of the second surface 70b. At this time, the resin material (A mask layer 78) of portions of the A mask layer 78, into which are pushed the convex portions 61 of the concave/convex patterns 60a and 60b, moves into the concave portions 62 of the concave/convex patterns 60a and 60b. This causes the convex portions 61 of the stampers 50A1a and 50B1a to be pushed deep enough into the A mask layers 78 of the first surface 70a and second surface 70b of the preform 70.

Next, both of the A mask layers 78 are cured by irradiation with ultraviolet rays via the stampers 50A1a and 50B1a, while maintaining the state of the stampers 50A1a and 50B1a being pressed against the preform 70. As a consequence, the concave/convex pattern 60a of the stamper 50A1a is transferred to the A mask layer 78 of the first surface 70a of the preform 70, whereby the concave/convex pattern (C concave/convex pattern in the present invention: not shown) having the inverted concave/convex positional relationship with respect to the concave/convex pattern 60a is formed on the A mask layer 78 (one surface in the present invention) of the first surface 70a, and the concave/convex pattern 60b of the stamper 50B1a is transferred to the A mask layer 78 of the second surface 70b of the preform 70, whereby the concave/convex pattern (D concave/convex pattern in the present invention: not shown) having the inverted concave/convex positional relationship with respect to the concave/convex pattern 60b is formed on the A mask layer 78 (the other surface in the present invention) of the second surface 70b. This completes the “pressing process” in the present invention.

It should be noted that although the above description has been given of the example in which the pressing device 4B starts the pressing process on the preform 70 immediately after attachment of the stampers 50A1a and 50B1a to the preform 70 is completed, this is not limitative, but it is also possible to use e.g., a thermoplastic resin material as a resin material for forming the A mask layers 78, and start the pressing process after heating the preform 70 and the stampers 50A1a and 50B1a to a predetermined temperature (e.g., a temperature not lower than the glass transition temperature of the A mask layers 78). If such a method is employed, it is possible to smoothly push the convex portions 61 into the A mask layers 78.

In this case, as shown in FIG. 10, in the preform 70 in the state in which the pressing process by the pressing device 4B is completed, similarly to the above-described state in which the pressing process by the pressing device 4A of the imprinting system 1A is completed, the stamper 50A1a is brought into intimate contact with the first surface 70a of the preform 70 in a manner extending beyond the outer periphery of the preform 70 by the length L4, and the stamper 50B1a is brought into intimate contact with the second surface 70b of the preform 70 in a manner extending beyond the outer periphery of the stamper 50A1a by the length L5. This makes it possible to smoothly peel the stamper 50B1a off the preform 70 (second surface 70b) by causing the peeling tool to catch the outer periphery of the stamper 50B1a extending beyond the stamper 50A1a, and smoothly peel the stamper 50A1a off the preform 70 (first surface 70a) by causing the peeling tool to catch the outer periphery of the stamper 50A1a extending beyond the preform 70.

It should be noted that the method of peeling the stampers 50A1a and 50B1a is not limited to the above-described method of peeling the stampers by causing the peeling tool to catch the outer peripheries of the stampers 50A1a and 50B1a. More specifically, when the stamper 50B1a is peeled, the above-described peeling device 6 (see FIGS. 11 and 12) can be used, for example. In this case, also when the imprinting process is carried out by the imprinting system 1B, similarly to the case where the imprinting process is carried out by the imprinting system 1A, the stamper 50A1a is brought into intimate contact with the first surface 70a of the preform 70 in a manner extending beyond the outer periphery of the preform 70 by the length L4, and the stamper 50B1a is brought into intimate contact with the second surface 70b of the preform 70 in a manner extending beyond the outer periphery of the stamper 50A1a by the length L5. Therefore, it is possible to bring the pin members 13 into abutment with the outer periphery of the stamper 50B1a without bringing the pin members 13 into contact with the stamper 50A1a and the preform 70, to thereby sufficiently bend the stamper 50B1a. This makes it possible to smoothly peel the stamper 50B1a off the second surface 70b of the preform 70. Further, the stamper 50A1a as well can be smoothly peeled off the first surface 70a of the preform 70 by using the aforementioned peeling device (device which performs peeling by pressing the outer periphery of the stamper 50A1a using the pin members while holding the preform 70 in a manner sandwiching the peripheral surface thereof).

As described hereinabove, by performing the stamper peeling process using the peeling tool, or the stamper peeling process using the peeling device 6 or the like, formation of the mask patterns on both the A mask layers 78 of the preform 70 is completed. After that, various etching processes are executed similarly to the sequence of operations of the process on the preform 70 which has the mask patterns formed on the A mask layers 78 thereof by the above-mentioned imprinting system 1A, whereby the magnetic disk 100 is completed, as shown in FIG. 2.

Next, an imprinting method according to still another embodiment of the present invention will be described with reference to the drawings. It should be noted that the same component elements as those of the imprinting systems 1A and 1B, the preform 70, and the stampers 50A1a and 50B1a are denoted by identical reference numerals and duplicate description thereof will be omitted.

Although in the above-described imprinting methods by the imprinting systems 1A and 1B, the B stamper attaching process is started after inverting upside down the preform 70 for which the A stamper attaching process in the present invention is completed and the A stamper (stamper 50A1a), the imprinting method and the imprinting system according to the present invention are not limited to this. More specifically, if an imprinting system 1C shown in FIG. 19 is used in place of the imprinting systems 1A and 1B, it is possible to execute the B stamper attaching process without inverting the preform 70 after completion of the A stamper attaching process.

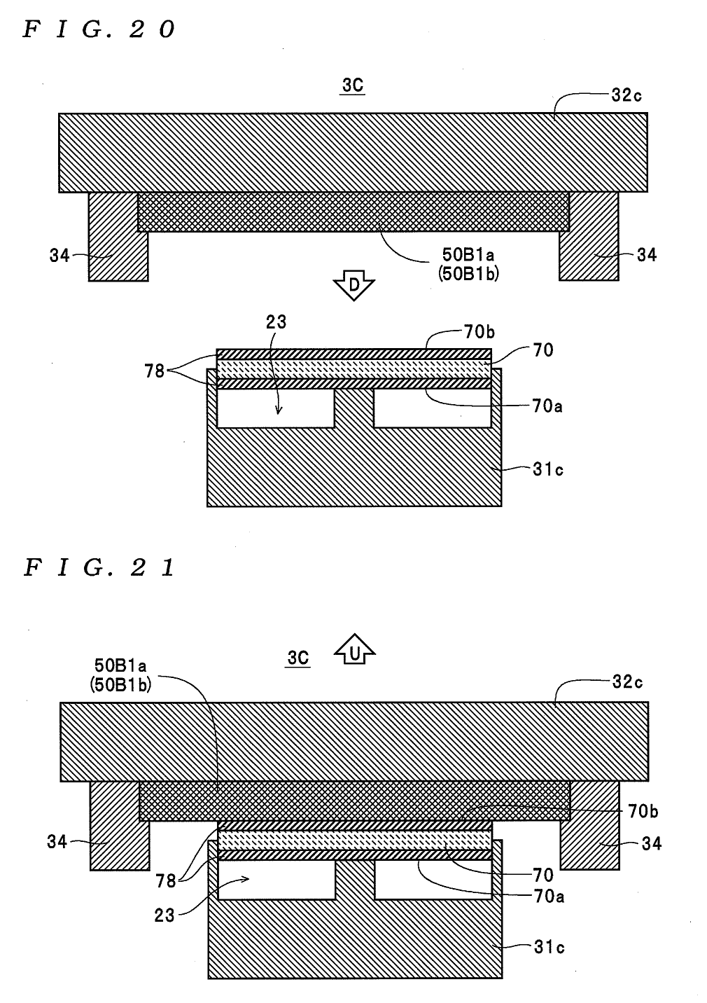

The imprinting system 1C is still another example of the imprinting system according to the present invention, and is comprised of a stamper attaching device 3C, a pressing device 4C, and a conveyor 5C. The stamper attaching device 3C attaches the B stamper in the present invention to the preform 70 (substrate), and as shown in FIG. 20, is comprised of a fixed base 31c, a movable base 32c, and a vertical movement device (not shown) that vertically moves the movable base 32c with respect to the fixed base 31c. In this case, the annular recess 23 is formed in an upper surface of the fixed base 31c, similarly to the fixed base 21a of the stamper attaching device 2A of the above-described imprinting system 1A. Further, the movable base 32c has a lower surface formed smooth and has the hollow cylindrical holding portion 34 mounted thereon which has the holding end that can be engaged with the outer periphery of the stamper 50B1a. In this case, the holding end of the holding portion 34 is formed to have a sufficient thickness for reliably holding the stamper 50B1a.

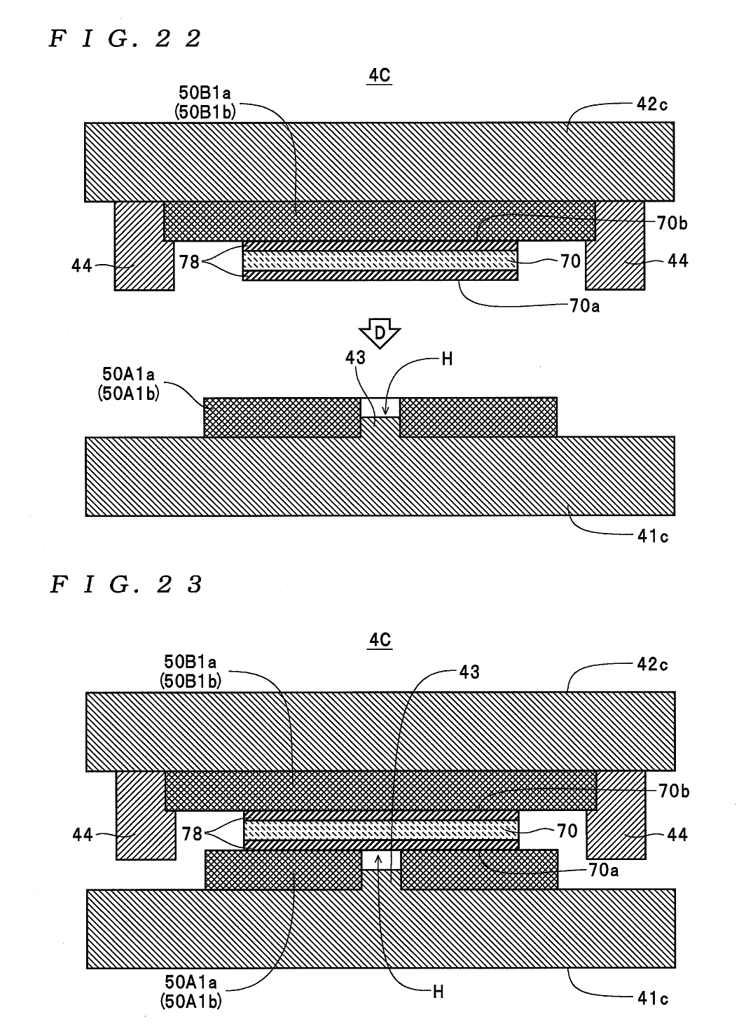

Further, the pressing device 4C attaches the A stamper in the present invention to the preform 70 (substrate), and performs a pressing process for forming the C pattern and a D pattern in the present invention. As shown in FIG. 22, the pressing device 4C is comprised of a fixed base 41c, a movable base 42c, and a vertical movement device (not shown) that vertically moves the movable base 42c with respect to the fixed base 41c. In this case, the protrusion 43 is formed on an upper surface of the fixed base 41c, similarly to the fixed base 41a of the pressing device 4A in the above-described imprinting system 1A. Further, on the movable base 42c is mounted the hollow cylindrical holding portion 44 having a holding end that can be engaged with the outer periphery of the stamper 50B1a. In this case, the holding end of the holding portion 44 is formed to have a sufficient thickness for reliably holding the stamper 50B1a. The conveyor 5C conveys the preform 70 having the stamper 50B1a attached thereto by the stamper attaching device 3C, to the pressing device 4C.

Next, a description will be given of still another method of manufacturing the magnetic disk 100, mainly of an imprinting method executed by the imprinting system 1C.

First, as shown in FIG. 20, the preform 70 is disposed on the fixed base 31c of the stamper attaching device 3C with the second surface 70b of the preform 70 facing upward. In doing this, the preform 70 is held such that the fixed base 31c is brought into contact with only the central area and outer periphery of the first surface 70a of the preform 70. Then, the stamper 50B1a is held (disposed)on the movable base 32c by the holding portion 34 with the surface of the stamper 50B1a formed with the concave/convex pattern 60b facing downward. In doing this, the holding portion 34 holds the outer periphery of the stamper 50B1a (the portion extending beyond the preform 70 in the state in which the stamper 50B1a has been attached to the preform 70, as described hereinafter). It is assumed that in the state in which disposition of the preform 70 and the stamper 50B1a is completed, the center of the preform 70 (e.g., the rotation center of the preform 70 when it is used as the magnetic disk 100) and the center of the stamper 50B1a (e.g., the center of the concentric data track pattern formed by the concave/convex pattern 60b) coincide with each other in the direction of the vertical motion of the movable base 32c with respect to the fixed base 31c, by carrying out the positioning operation.

Subsequently, the movable base 32c is moved downward with respect to the fixed base 31c in a direction indicated by an arrow D in FIG. 20, and as shown in FIG. 21, the surface formed with the concave/convex pattern 60b of the stamper 50B1a disposed on the movable base 32c is pressed against the second surface 70b (A mask layer 78) of the preform 70 on the fixed base 31c. This brings the second surface 70b of the preform 70 and the surface of the stamper 50B1a formed with the concave/convex pattern 60b (the protruding end face of each convex portion 61) into intimate contact with each other, whereby attachment of the stamper 50B1a to the preform 70 is completed.

Subsequently, after the movable base 32c is moved upward in a direction indicated by an arrow U in FIG. 21, the conveyor 5C removes the preform 70 having the stamper 50B1a attached thereto from the stamper attaching device 3C, and conveys the preform 70 to the pressing device 4C. In doing this, as shown in FIG. 22, the conveyor 5C disposes the preform 70 on the movable base 42c of the pressing device 4C such that the stamper 50B1a is held by the holding portion 44, while maintaining the state of the first surface 70a of the preform 70 facing downward. In doing this, the holding portion 44 holds the outer periphery of the stamper 50B1a (the portion extending beyond both the preform 70 and the stamper 50A1a in the state in which the stamper 50B1a has been attached to the preform 70, as described hereinafter).

Then, the conveyor 5C disposes the stamper 50A1a on the fixed base 41c with the surface of the stamper 50A1a formed with the concave/convex pattern 60a facing upward. In this case, as described hereinabove, the fixed base 41c is formed with the protrusion 43 the outer diameter of which is equal to the inner diameter of the central hole H of the stamper 50A1a. Therefore, the stamper 50A1a is disposed on the fixed base 41c in a manner fitting the protrusion 43 into the central hole H of the stamper 50A1a, whereby the stamper 50A1a is positioned with respect to the fixed base 41c. It is assumed that in the state in which disposition of the preform 70 (stamper 50B1a) and the stamper 50A1a is completed, the center of the preform 70 (e.g., the rotation center of the preform 70 when it is used as the magnetic disk 100) and the center of the stampers 50A1a and 50B1a (e.g., the center of a concentric data track pattern formed by the concave/convex patterns 60a and 60b) coincide with each other in the direction of the vertical motion of the movable base 42c with respect to the fixed base 41c, by carrying out the positioning operation.

Subsequently, the movable base 42c is moved downward with respect to the fixed base 41c in a direction indicated by an arrow D in FIG. 22, and as shown in FIG. 23, the first surface 70a (A mask layer 78) of the preform 70 held by the movable base 42c is pressed against the surface formed with the concave/convex pattern 60a of the stamper 50A1a disposed on the fixed base 41c. This brings the first surface 70a of the preform 70 and the surface of the stamper 50A1a formed with the concave/convex pattern 60a (the protruding end face of each convex portion 61) into intimate contact with each other, whereby attachment of the stamper 50A1a to the preform 70 is completed.

In this case, the diameter L3 of the stamper 50B1a disposed on the movable base 42c is sufficiently larger than the diameter L2 of the stamper 50A1a disposed on the fixed base 41c and the diameter L1 of the preform 70 also disposed on the fixed base 41c, and hence in attaching the stamper 50B1a to the preform 70, it is possible to prevent the foremost end of the holding portion 44 which holds the stamper 50B1a, from being brought into abutment with the outer periphery of the stamper 50A1a and that of the preform 70. Further, in the state in which attachment of the stamper 50A1a to the preform 70 is completed, the whole area of the outer periphery of the stamper 50B1a (an example of “at least part” in the present invention being a whole area) does not overlap the stamper 50A1a in the direction of the thickness of the preform 70.

Subsequently, the movable base 42c is moved further downward with respect to the fixed base 41c, to thereby press the stamper 50A1a, the preform 70, and the stamper 50B1a. In doing this, the concave/convex pattern 60a of the stamper 50A1a attached to the first surface 70a of the preform 70 is pressed against the first surface 70a, and the concave/convex pattern 60b of the stamper 50B1a attached to the second surface 70b of the preform 70 is pressed against the second surface 70b. More specifically, as the movable base 42c moves downward with respect to the fixed base 41c, the concave/convex pattern 60a of the stamper 50A1a is pressed against the A mask layer 78 of the first surface 70a of the preform 70, whereby each convex portion 61 of the concave/convex pattern 60a is pushed into the A mask layer 78 of the first surface 70a, and the concave/convex pattern 60b of the stamper 50B1a is pressed against the A mask layer 78 of the second surface 70b of the preform 70, whereby each convex portion 61 of the concave/convex pattern 60b is pushed into the A mask layer 78 of the second surface 70b.

At this time, the resin material (A mask layer 78) of portions of the A mask layer 78, into which are pushed the convex portions 61 of the concave/convex patterns 60a and 60b, moves into the concave portions 62 of the concave/convex patterns 60a and 60b. This causes the convex portions 61 of the stampers 50A1a and 50B1a to be pushed deep enough into the A mask layers 78 of the first surface 70a and second surface 70b of the preform 70. Then, both of the A mask layers 78 are cured by irradiation with ultraviolet rays via the stampers 50A1a and 50B1a while maintaining the state of the stampers 50A1a and 50B1a being pressed against the preform 70. As a consequence, the concave/convex pattern 60a of the stamper 50A1a is transferred to the A mask layer 78 of the first surface 70a of the preform 70, whereby the concave/convex pattern (C concave/convex pattern in the present invention: not shown) having the inverted concave/convex positional relationship with respect to the concave/convex pattern 60a is formed on the A mask layer 78 (one surface in the present invention) of the first surface 70a, and the concave/convex pattern 60b of the stamper 50B1a is transferred to the A mask layer 78 of the second surface 70b of the preform 70, whereby the concave/convex pattern (D concave/convex pattern in the present invention: not shown) having the inverted concave/convex positional relationship with respect to the concave/convex pattern 60b is formed on the A mask layer 78 (the other surface in the present invention) of the second surface 70b. This completes the pressing process in the present invention.

It should be noted that although the above description has been given of the example in which the pressing device 4C starts the pressing process on the preform 70 immediately after attachment of the stampers 50A1a and 50B1a to the preform 70 is completed, this is not limitative, but it is also possible to use e.g., a thermoplastic resin material as a resin material for forming the A mask layers 78, and start the pressing process after heating the preform 70 and the stampers 50A1a and 50B1a to a predetermined temperature (e.g., a temperature not lower than the glass transition temperature of the A mask layers 78). If such a method is employed, it is possible to smoothly push the convex portions 61 into the A mask layers 78.

In this case, as shown in FIG. 10, in the preform 70 in the state in which the pressing process by the pressing device 4C is completed, similarly to the above-described state in which the pressing processes by the pressing devices 4A and 4B of the respective imprinting systems 1A and 1B are completed, the stamper 50A1a is brought into intimate contact with the first surface 70a of the preform 70 in a manner extending beyond the outer periphery of the preform 70 by the length L4, and the stamper 50B1a is brought into intimate contact with the second surface 70b of the preform 70 in a manner extending beyond the outer periphery of the stamper 50A1a by the length L5. This makes it possible to smoothly peel the stamper 50B1a off the preform 70 (second surface 70b) by causing the peeling tool to catch the outer periphery of the stamper 50B1a extending beyond the stamper 50A1a, and smoothly peel the stamper 50A1a from the preform 70 (first surface 70a) by causing the peeling tool to catch the outer periphery of the stamper 50A1a extending beyond the preform 70.

It should be noted that the method of peeling the stampers 50A1a and 50B1a is not limited to the above-described method of peeling the stampers by causing the peeling tool to catch the outer peripheries of the stampers 50A1a and 50B1a. More specifically, e.g., when the stamper 50B1a is peeled, the above-described peeling device 6 (see FIGS. 11 and 12) can be used. In this case, also when the imprinting process is carried out by the imprinting system 1C, similarly to the case where the imprinting process is carried out by the imprinting systems 1A and 1B, the stamper 50A1a is brought into intimate contact with the first surface 70a of the preform 70 in a manner extending beyond the outer periphery of the preform 70 by the length L4, and the stamper 50B1a is brought into intimate contact with the second surface 70b of the preform 70 in a manner extending beyond the outer periphery of the stamper 50A1a by the length L5. Therefore, it is possible to bring the pin members 13 into abutment with the outer periphery of the stamper 50B1a without bringing the pin members 13 into contact with the stamper 50A1a and the preform 70, to thereby sufficiently bend the stamper 50B1a. This makes it possible to smoothly peel the stamper 50B1a off the second surface 70b of the preform 70. Further, the stamper 50A1a as well can be smoothly peeled off the first surface 70a of the preform 70 by using the aforementioned peeling device (device which performs peeling by pressing the outer periphery of the stamper 50A1a using the pin members while holding the preform 70 in a manner sandwiching the peripheral surface thereof).

As described hereinabove, by performing the stamper peeling process using the peeling tool, or the stamper peeling process using the peeling device 6 or the like, formation of the mask patterns on both the A mask layers 78 of the preform 70 is completed. After that, various etching processes are executed similarly to the sequence of operations of the process on the preform 70 which has the mask patterns formed on the A mask layers 78 thereof by the above-described imprinting system 1A, whereby the magnetic disk 100 is completed, as shown in FIG. 2.

As described hereinabove, according to the imprinting methods by the above-mentioned imprinting systems 1A to 1C, the stampers 50A1a (50A1b) and 50B1a (50B1b), which have similar shapes in plan view and plane areas larger than that of the preform 70, are used as the A stamper (A1 stamper) and the B stamper (B1 stamper) in the present invention. Further, the C concave/convex pattern and the D concave/convex pattern in the present invention are formed on the preform 70 by pressing the stampers 50A1a (50A1b) and 50B1a (50B1b) against the first surface 70a and second surface 70b of the preform 70, respectively, such that at least part (the whole area, in the illustrated examples) of the outer periphery of the stamper 50B1a (50B1b) does not overlap the stamper 50A1a (50A1b) in the direction of the thickness of the preform 70. Further, in the above-described methods of manufacturing the magnetic disk 100, the C concave/convex pattern and the D concave/convex pattern in the present invention are formed by the imprinting methods according to the present invention, and the magnetic disk 100 is manufactured using the formed C concave/convex pattern and D concave/convex pattern.

According to the imprinting methods by the imprinting systems 1A to 1C, and the methods of manufacturing the magnetic disk 100, in the state in which the pressing process is completed, it is possible to cause the outer periphery of the stamper 50A1a (50A1b) to extend beyond the preform 70 by the length L4, and cause the outer periphery of the stamper 50B1a (50B1b) to extend beyond the stamper 50A1a (50A1b) by the length L5, thereby making it possible to easily peel the stampers 50A1a (50A1b) and 50B1a (50B1b) off the preform 70 by causing e.g., the peeling tool to catch the outer peripheries of the stampers 50A1a (50A1b) and 50B1a (50B1b), or by pressing the outer peripheries of the stampers 50A1a (50A1b) and 50B1a (50B1b) by bringing the pin members or the like into abutment with the outer peripheries. Further, according to the imprinting methods and the methods of manufacturing the magnetic disk 100, by holding a portion of the stamper 50B1a (50B1b) extending beyond the stamper 50A1a (50A1b), it is possible, e.g., during the pressing process or the like, to prevent a holding portion holding the stamper 50B1a (50B1b) (the holding portion 44 of the movable base 42a of the pressing device 4A, the holding portion 34 of the fixed base 32b of the stamper attaching device 3B, or the holding portion 44 of the movable base 42c of the pressing device 4C, in the illustrated examples) from being brought into contact with the stamper 50A1a (50A1b) or the preform 70. This makes it possible to reliably press the stampers 50A1a (50A1b) and 50B1a (50B1b) against the first surface 70a and second surface 70b of the preform 70 to thereby form desired concave/convex patterns with high accuracy.

Further, in the imprinting methods by the imprinting systems 1A and 1B, and the method of manufacturing the magnetic disk 100, there sequentially carried out are: the A stamper attaching process, in which the preform 70 is disposed on the first lower base (the fixed base 21a or the movable base 21b) with one surface (the first surface 70a, in the illustrated examples) facing upward, and the stamper 50A1a (50A1b) is disposed on the first upper base (the movable base 22a or the fixed base 22b) with the surface of the stamper 50A1a (50A1b) formed with the concave/convex pattern 60a (A concave/convex pattern) facing downward, whereafter the first upper base is caused to approach relative to the first lower base (the movable base 22a is moved downward with respect to the fixed base 21a, or the movable base 21b is moved upward with respect to the fixed base 22b), to thereby attach the stamper 50A1a (50A1b) to the first surface 70a of the preform 70; the B stamper attaching process, in which the stamper 50A1a (50A1b) is disposed on the second lower base (the fixed base 41a or the movable base 31b) with the second surface 70b of the preform 70 having the stamper 50A1a (50A1b) attached thereto facing upward, and the stamper 50B1a (50B1b) is disposed on the second upper base (the movable base 42a or the fixed base 32b) with the surface of the stamper 50B1a (50B1b) formed with the concave/convex pattern 60b (B concave/convex pattern) facing downward, whereafter the second upper base is caused to approach relative to the second lower base (the movable base 42a is moved downward with respect to the fixed base 41a, or the movable base 31b is moved upward with respect to the fixed base 32b), to thereby attach the stamper 50B1a (50B1b) to the second surface 70b of the preform 70; and the pressing process, in which the laminate of the stamper 50A1a (50A1b), the preform 70, and the stamper 50B1a (50B1b) is pressed using the pressing device (pressing device 4A or 4B) including the third lower base (the fixed base 41a or the fixed base 41b) and the third upper base (the movable base 42a or the movable base 42b) to thereby form the C concave/convex pattern and the D concave/convex pattern on the preform 70.

Further, the imprinting systems 1A and 1B is comprised of the A stamper attaching device (the stamper attaching device 2A or 2B), which includes the first lower base (the fixed base 21a or the movable base 21b) on which the preform 70 can be disposed with the first surface 70a facing upward, and the first upper base (the movable base 22a or the fixed base 22b) on which the stamper 50A1a (50A1b) can be disposed with the surface thereof formed with the concave/convex pattern 60a facing downward, and is configured to be capable of attaching the stamper 50A1a (50A1b) to the first surface 70a of the preform 70 by causing the first upper base to approach relative to the first lower base (the movable base 22a is moved downward with respect to the fixed base 21a, or the movable base 21b is moved upward with respect to the fixed base 22b); the B stamper attaching device (the pressing device 4A or the stamper attaching device 3B), which includes the second lower base (the fixed base 41a or the movable base 31b) on which the stamper 50A1a (50A1b) can be disposed with the second surface 70b of the preform 70 having the stamper 50A1a (50A1b) attached thereto facing upward, and the second upper base (the movable base 42a or the fixed base 32b) on which the stamper 50B1a (50B1b) can be disposed with the surface thereof formed with the concave/convex pattern 60b facing downward, and is configured to be capable of attaching the stamper 50B1a (50B1b) to the second surface 70b of the preform 70 by causing the second upper base to approach relative to the second lower base (the movable base 42a is moved downward with respect to the fixed base 41a, or the movable base 31b is moved upward with respect to the fixed base 32b); and the pressing device (pressing device 4A or 4B), which includes the third lower base (the fixed base 41a or the fixed base 41b) and the third upper base (the movable base 42a or the movable base 42b), and presses the laminate of the stamper 50A1a (50A1b), the preform 70, and the stamper 50B1a (50B1b) to thereby form the C concave/convex pattern and the D concave/convex pattern on the preform 70.

Therefore, according to the imprinting systems 1A and 1B, the imprinting methods by the imprinting systems 1A and 1B, and the methods of manufacturing the magnetic disk 100, a direction in which the first upper base is caused to approach relative to the first lower base in the A stamper attaching process in the present invention (a direction in which the movable base 22a is caused to approach the fixed base 21a in the stamper attaching device 2A, or the movable base 21b is caused to approach the fixed base 22b in the stamper attaching device 2B, in the illustrated examples) can coincide with a direction in which the second upper base is caused to approach relative to the second lower base in the B stamper attaching process in the present invention (a direction in which the movable base 42a is caused to approach the fixed base 41a in the pressing device 4A, or the movable base 31b is caused to approach the fixed base 32b in the stamper attaching device 3B, in the illustrated examples). This makes it possible to carry out the imprinting processes by using equipment for the A stamper attaching process (the stamper attaching device 2A or 2B, in the illustrated examples), and equipment for the B stamper attaching process (the pressing device 4A or the stamper attaching device 3B, in the illustrated examples), which are of the same kind in respect of a direction in which a movable base is moved toward a fixed base and a direction in which the movable base is moved away from the fixed base.

Further, the imprinting systems 1A to 1C are configured such that the C concave/convex pattern can be formed on the first surface 70a of the preform 70, and the D concave/convex pattern can be formed on the second surface 70b of the preform 70, by the imprinting methods according to the present invention, whereby it is possible to easily peel the stampers 50A1a (50A1b) and 50B1a (50B1b) off the preform 70, and reliably press the stampers 50A1a (50A1b) and 50B1a (50B1b) against the first surface 70a and second surface 70b of the preform 70, to thereby form desired concave/convex patterns with high accuracy.

It should be noted that the present invention is not limited to the above-described methods and constructions. For example, although the figures referred to in the descriptions of the imprinting methods by the imprinting systems 1A to 1C show the construction in which the central hole H is formed only in the A stamper in the present invention, this is not limitative, but the central hole H may be formed in the B stamper and the substrate in the present invention as well. Further, although the description has been given of the imprinting method which uses the stampers 50A1a and 50B1a similar (both circular, in the illustrated example) in shape in plan view, or the stampers 50A1b and 50B1b similar (square, in the illustrated example) in shape in plan view, the constructions of the A stamper and the B stamper in the present invention are not limited to this.

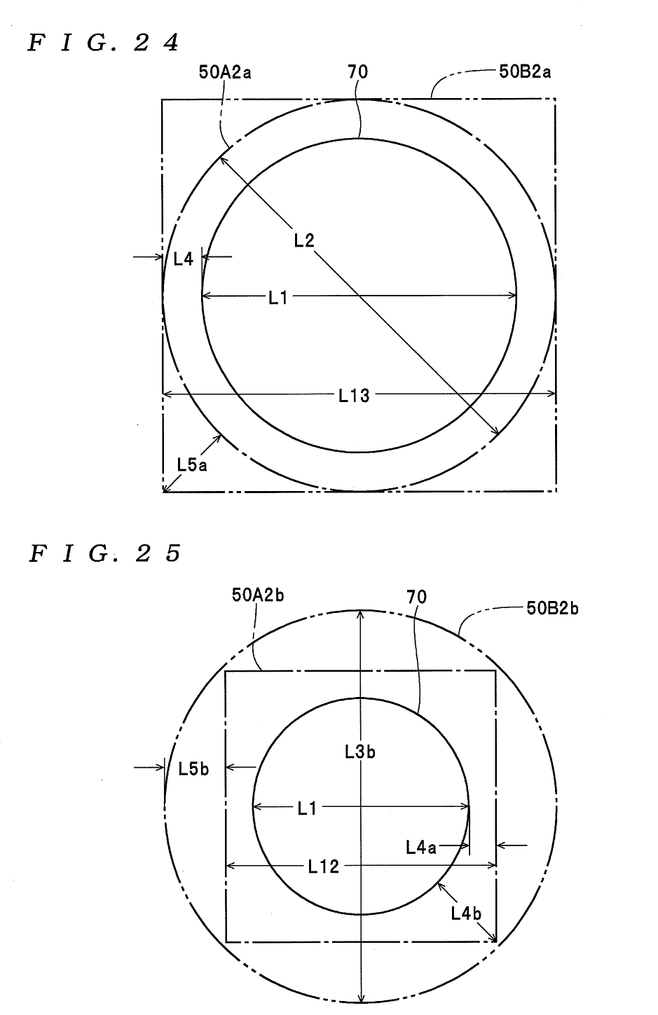

More specifically, as shown in FIG. 24, a circular stamper 50A2a (an example of an A2 stamper in the present invention), a diameter L2 of which is longer than the diameter L1 of the preform 70 by twice the length L4, and a square stamper 50B2a (an example of a B2 stamper in the present invention), the length L13 of each side of which is equal to the diameter L2 of the stamper 50A2a, can be used as “the A stamper and the B stamper” in the present invention, by way of example. In this case, the stampers 50A2a and 50B2a are formed such that the plane areas thereof become larger than the plane area of the preform 70, respectively. It should be noted that it is possible to employ a construction in which the length L13 of each side of the stamper 50B2a is defined to be longer than the diameter L2 of the stamper 50A2a, or a construction in which the length L13 is defined to be slightly shorter than the diameter L2 of the stamper 50A2a.

In an imprinting method using the stampers 50A2a and 50B2a, in a state in which the stampers 50A2a and 50B2a are attached to the first surface 70a and second surface 70b of the preform 70, respectively, as shown in FIG. 24, the outer periphery of the stamper 50A2a extends beyond the preform 70 by the length L4, and four corner portions of the stamper 50B2a extend beyond the stamper 50A2a by a length L5a (part of the outer periphery of the stamper 50B2a does not overlap the stamper 50A2a in the direction of the thickness of the preform 70). Therefore, when these stampers 50A2a and 50B2a are used in place of the above-described stampers 50A1a and 50B1a, during the A stamper attaching process in the present invention, the outer periphery of the stamper 50A2a (a portion extending beyond the preform 70 in a state in which the A stamper attaching process is completed) is held by the holding portion, and during the B stamper attaching process in the present invention, the outer periphery of the stamper 50B2a (a portion extending beyond both the preform 70 and the stamper 50A2a in a state in which the B stamper attaching process is completed) is held by the holding portion. This makes it possible to provide the same advantageous effects as provided by the imprinting method using the stampers 50A1a and 50B1a.

Further, as shown in FIG. 25, a square stamper 50A2b (another example of the A2 stamper in the present invention), the length L12 of each side of which is longer than the diameter L1 of the preform 70 by twice a length L4a, and a circular stamper 50B2b (another example of the B2 stamper in the present invention), a diameter L3b of which is longer than the length L12 of each side of the stamper 50A2b by twice a length L5b, can be used as “the A stamper and the B stamper” in the present invention. In this case, the stampers 50A2b and 50B2b are formed such that the plane areas thereof become larger than the plane area of the preform 70, respectively.

In an imprinting method using the stampers 50A2b and 50B2b, in a state in which the stampers 50A2b and 50B2b have been attached to the first surface 70a and second surface 70b of the preform 70, respectively, as shown in FIG. 25, the outer periphery of the stamper 50A2b extends beyond the preform 70 by a range of the length L4a to a length L4b, and the stamper 50B2a extends beyond the stamper 50A2b by the length L5b (part of the outer periphery of the stamper 50B2b does not overlap the stamper 50A2b in the direction of the thickness of the preform 70). Therefore, when the stampers 50A2b and 50B2b are used in place of the above-described stampers 50A1a and 50B1a, during the A stamper attaching process in the present invention, the outer periphery of the stamper 50A2b (a portion extending beyond the preform 70 in the state in which the A stamper attaching process is completed) is held by the holding portion, and during the B stamper attaching process in the present invention, the outer periphery of the stamper 50B2b (a portion extending beyond both the preform 70 and the stamper 50A2b in the state in which the B stamper attaching process is completed) is held by the holding portion. This makes it possible to provide the same advantageous effects as provided by the imprinting method using the stampers 50A1a and 50B1a.

As described above, the C concave/convex pattern and the D concave/convex pattern in the present invention are formed by using the stampers 50A2a (50A2b) and 50B2a (50B2b), which have different shapes from each other in plan view and whose plane areas are larger than that of the preform 70, as the A stamper (A2 stamper) and the B stamper (B2 stamper) in the present invention, and pressing the stampers 50A2a (50A2b) and 50B2a (50B2b) against the first surface 70a and second surface 70b of the preform 70, respectively, such that part of the outer periphery of the stamper 50B2a (50B2b) does not overlap the stamper 50A2a (50A2b) in the direction of the thickness of the preform 70. This makes it possible, similarly to the above-described imprinting method using the stampers 50A1a (50A1b) and 50B1a (50B1b), in the state in which the pressing process is completed, to cause the outer periphery of the stamper 50A2a (50A2b) to extend beyond the preform 70 by the length L4 or a range of the length L4a to the length L4b, and cause the outer periphery of the stamper 50B2a (50B2b) to extend beyond the stamper 50A2a (50A2b) by the length L5a or L5b. Therefore, it is possible to easily peel the stampers 50A2a (50A2b) and 50B2a (50B2b) off the preform 70 by causing e.g., the peeling tool to catch the outer peripheries of the stampers 50A2a (50A2b) and 50B2a (50B2b), or pressing the outer peripheries of the stampers 50A2a (50A2b) and 50B2a (50B2b) by bringing the pin members or the like into abutment with the outer peripheries. Further, according to this imprinting method, a portion of the stamper 50B2a (50B2b) extending beyond the stamper 50A2a (50A2b) is held, whereby e.g., during the pressing process, it is possible to prevent the holding portion holding the stamper 50B2a (50B2b) from being brought into contact with the stamper 50A2a (50A2b) and the preform 70, thereby making it possible to reliably press the stampers 50A2a (50A2b) and 50B2a (50B2b) against the first surface 70a and second surface 70b of the preform 70 to thereby form desired concave/convex patterns with high accuracy.

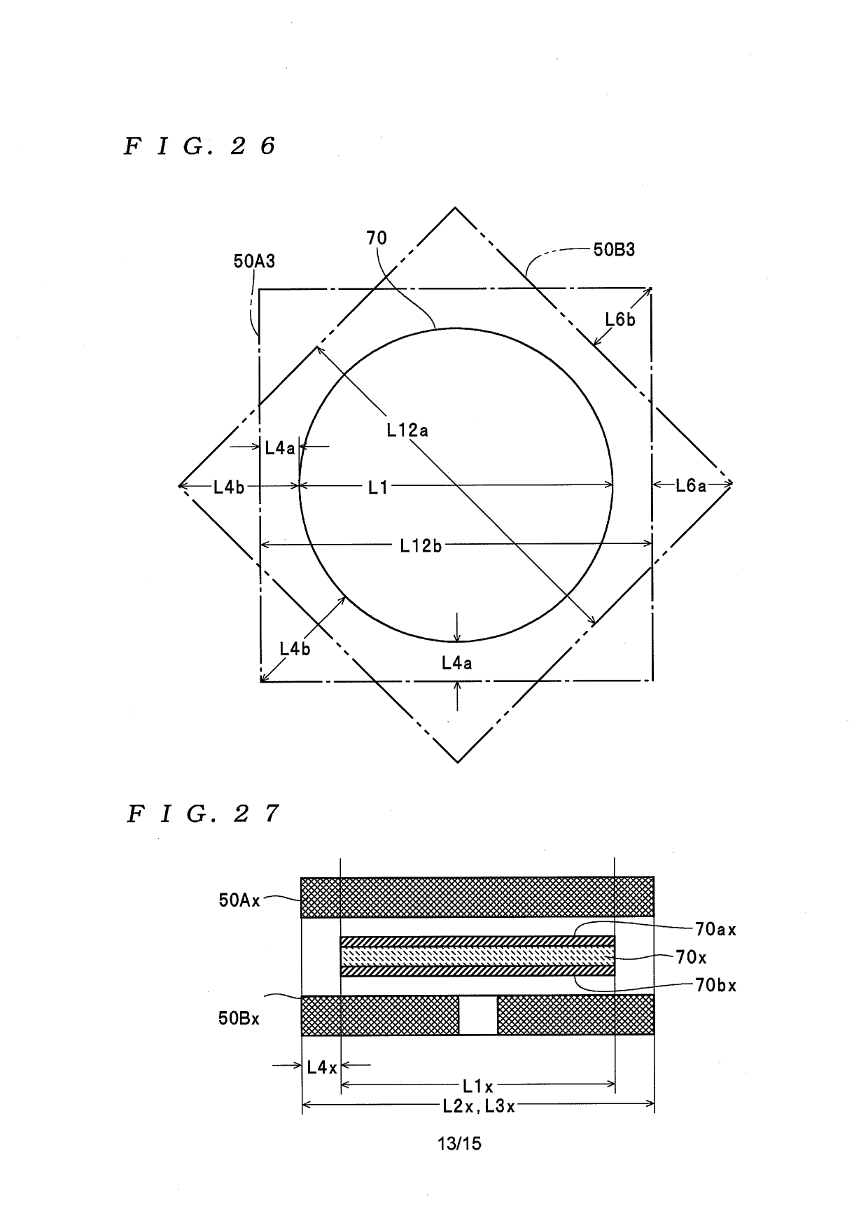

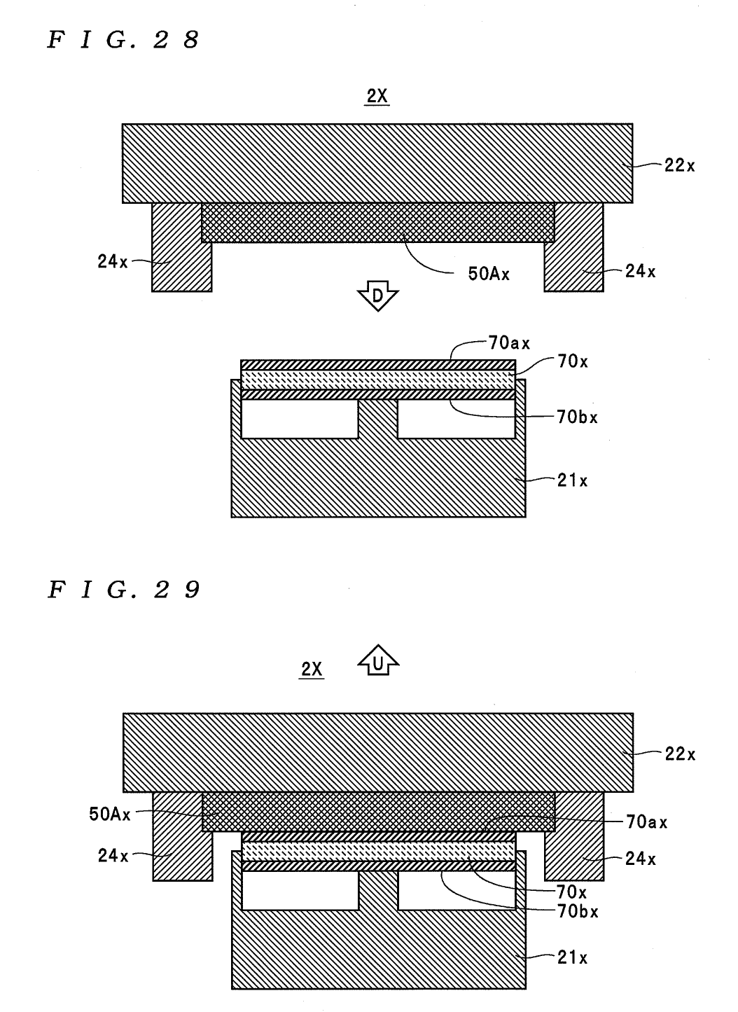

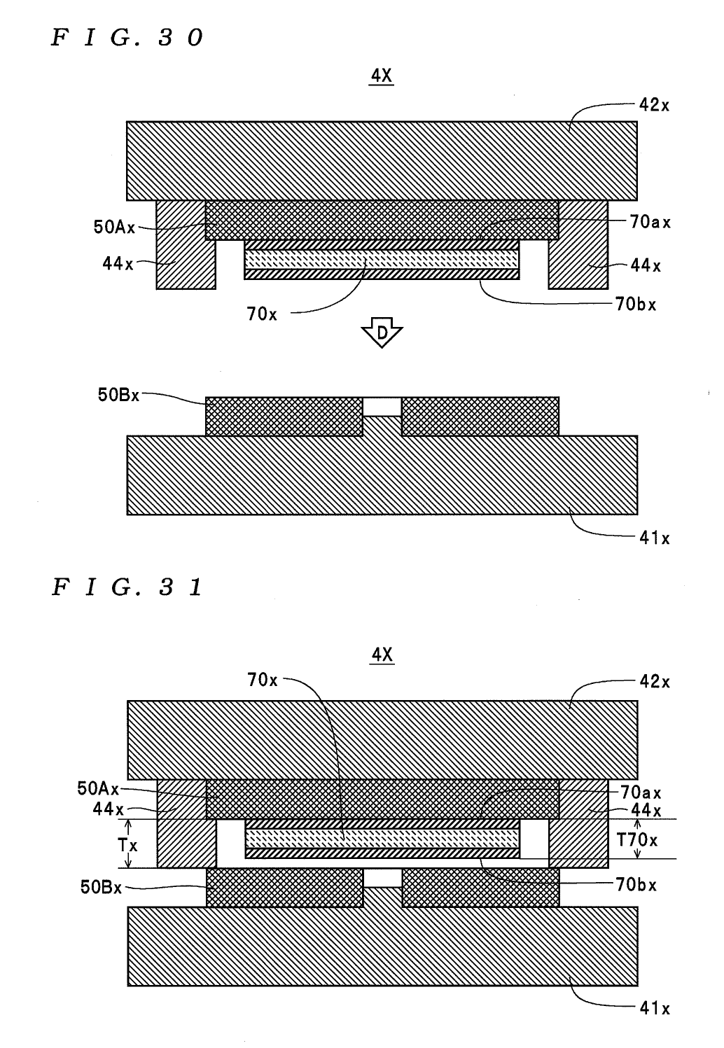

Further, as shown in FIG. 26, stampers 50A3 and 50B3 (examples of an A3 stamper and a B3 stamper in the present invention), which have congruent shapes in plan view (square shapes which have equal plane areas, and lengths L12a and L12b of each sides of which are equal to each other, in the illustrated example), and plane areas larger than that of the preform 70, can be used as the “the A stamper and the B stamper” in the present invention. In the imprinting method using the stampers 50A3 and 50B3, the stampers 50A3 and 50B3 are attached to the first surface 70a and second surface 70b of the preform 70, respectively, in a state in which the stamper 50B3 is rotated about the center of the preform 70 and the stamper 50A3 by 45 degrees with respect to the stamper 50A3, by way of example. When the stampers 50A3 and 50B3 are attached, as shown in FIG. 26, the outer periphery of the stamper 50A3 extends beyond the preform 70 by a range of the length L4a to the length L4b, and four corner portions of the stamper 50B3 extend beyond the stamper 50A3 by a length L6a (part of the outer periphery of the stamper 50B3 does not overlap the stamper 50A3 in the direction of the thickness of the preform 70).

Therefore, when the stampers 50A3 and 50B3 are used in place of the above-described stampers 50A1a and 50B1a, during the A stamper attaching process in the present invention, the outer periphery of the stamper 50A3 (a portion extending beyond the preform 70 in the state in which the A stamper attaching process is completed: e.g., four corner portions of the stamper 50A3) is held by the holding portion, and during the B stamper attaching process in the present invention, the corner portions of the stamper 50B3 (portions extending beyond both the preform 70 and the stamper 50A3 in the state in which the B stamper attaching process is completed) are held by the holding portion. This makes it possible to provide the same advantageous effects as provided by the imprinting method using the stampers 50A1a and 50B1a. It should be noted that in this state, the four corner portions of the stamper 50A3 extend beyond the stamper 50B3 by a length L6b which is equal to the length L6a (part of the outer periphery of the stamper 50A3 does not overlap the stamper 50B3 in the direction of the thickness of the preform 70).

As described above, the C concave/convex pattern and the D concave/convex pattern in the present invention are formed on the preform 70 by using the stampers 50A3 and 50B3, which have congruent shapes in plan view and plane areas larger than that of the preform 70, as the A stamper (A3 stamper) and the B stamper (B3 stamper) in the present invention, and pressing the stampers 50A3 and 50B3 against the first surface 70a and second surface 70b of the preform 70, respectively, such that part of the outer periphery of one (e.g., the stamper 50A3) of the stampers 50A3 and 50B3 does not overlap the other (e.g., the stamper 50B3, in this example) of the stampers 50A3 and 50B3 in the direction of the thickness of the preform 70. This makes it possible, similarly to the above-described imprinting method using the stampers 50A1a (50A1b) and 50B1a (50B1b), and the imprinting method using the stampers 50A2a (50A2b) and 50B2a (50B2b), in the state in which the pressing process is completed, to cause the outer periphery of the stamper 50A3 to extend beyond the preform 70 by a range of the length L4a to the length L4b, and cause the outer periphery of the stamper 50B3 to extend beyond the stamper 50A3 by the length L6a (cause the outer periphery of the stamper 50A3 to extend beyond the stamper 50B3 by the length L6b). Therefore, it is possible to easily peel the stampers 50A3 and 50B3 off the preform 70 by causing e.g., the peeling tool to catch the outer peripheries of the stampers 50A3 and 50B3, or pressing the outer peripheries of the stampers 50A3 and 50B3 by bringing the pin members or the like into abutment with the outer peripheries. Further, according to the above imprinting method, a portion of the stamper 50B3 extending beyond the stamper 50A3 is held, whereby e.g., during the pressing process, it is possible to prevent the holding portion holding the stamper 50B3 from being brought into contact with the stamper 50A3 or the preform 70, thereby making it possible to reliably press the stampers 50A3 and 50B3 against the first surface 70a and second surface 70b of the preform 70 to thereby form desired concave/convex patterns with high accuracy.

Further, although the above description has been given of the example in which the A stamper and the B stamper in the present invention are formed to have a circular or square shape, the shapes of the A stamper and the B stamper in plan view are not limited to these, but they can have various shapes, such as polygons other than the square shape, and ellipses. Furthermore, although the above description has been given of the example in which are used resin stampers (stampers 50A1a, 50B1a, etc.) made of a resin material and molded by injection molding using metal stampers, this is not limitative, but stampers in the form of a flat plate which are e.g., made of quartz may be used as the A stamper and the B stamper in the present invention. Further, when the A mask layer 78 is made of a thermoplastic resin material or a thermosetting resin material in place of the aforementioned ultraviolet-curing resin material, stampers made of metal materials, such as nickel, may be used as the A stamper and the B stamper in the present invention.

Furthermore, although the above description has been given of the construction in which one of the first lower base and the first upper base is vertically moved with respect to the other, the construction in which one of the second lower base and the second upper base is vertically moved with respect to the other, and the construction in which one of the third lower base and the third upper base is vertically moved with respect to the other, the imprinting method and the imprinting system according to the present invention are not limited to these, but it is possible to employ a construction in which both the first lower base and the first upper base are vertically moved toward and away from each other, a construction in which both the second lower base and the second upper base are vertically moved toward and away from each other, and a construction in which both the third lower base and the third upper base are vertically moved toward and away from each other.

What is claimed is:

1. An imprinting method in which an A stamper formed with an A concave/convex pattern is pressed against one surface of a substrate to thereby transfer the A concave/convex pattern to the one surface, and a B stamper formed with a B concave/convex pattern is pressed against the other surface of the substrate to thereby transfer the B concave/convex pattern to the other surface, whereby a C concave/convex pattern having an inverted concave/convex positional relationship with respect to the A concave/convex pattern is formed on the one surface of the substrate, and a D concave/convex pattern having an inverted concave/convex positional relationship with respect to the B concave/convex pattern is formed on the other surface of the substrate,
wherein an A1 stamper and a B1 stamper which have similar shapes in plan view and plane areas larger than that of the substrate are used as the A stamper and the B stamper, and the A1 stamper and the B1 stamper are pressed against opposite surfaces of the substrate, respectively, such that at least part of an outer periphery of one of the A1 stamper and the B1 stamper does not overlap the other in a direction of a thickness of the substrate.

2. An imprinting method in which an A stamper formed with an A concave/convex pattern is pressed against one surface of a substrate to thereby transfer the A concave/convex pattern to the one surface, and a B stamper formed with a B concave/convex pattern is pressed against the other surface of the substrate to thereby transfer the B concave/convex pattern to the other surface, whereby a C concave/convex pattern having an inverted concave/convex positional relationship with respect to the A concave/convex pattern is formed on the one surface of the substrate, and a D concave/convex pattern having an inverted concave/convex positional relationship with respect to the B concave/convex pattern is formed on the other surface of the substrate,
wherein an A2 stamper and a B2 stamper which have different shapes in plan view and plane areas larger than that of the substrate are used as the A stamper and the B stamper, and the A2 stamper and the B2 stamper are pressed against opposite surfaces of the substrate, respectively, such that at least part of an outer periphery of one of the A2 stamper and the B2 stamper does not overlap the other in a direction of a thickness of the substrate.

3. An imprinting method in which an A stamper formed with an A concave/convex pattern is pressed against one surface of a substrate to thereby transfer the A concave/convex pattern to the one surface, and a B stamper formed with a B concave/convex pattern is pressed against the other surface of the substrate to thereby transfer the B concave/convex pattern to the other surface, whereby a C concave/convex pattern having an inverted concave/convex positional relationship with respect to the A concave/convex pattern is formed on the one surface of the substrate, and a D concave/convex pattern having an inverted concave/convex positional relationship with respect to the B concave/convex pattern is formed on the other surface of the substrate,
wherein an A3 stamper and a B3 stamper which have congruent shapes in plan view and plane areas larger than that of the substrate are used as the A stamper and the B stamper, and the A3 stamper and the B3 stamper are pressed against opposite surfaces of the substrate, respectively, such that part of an outer periphery of one of the A3 stamper and the B3 stamper does not overlap the other in a direction of a thickness of the substrate.

4. The imprinting method according to claim 1, wherein an A stamper attaching process in which the substrate is disposed on a first lower base with the one surface thereof facing upward, and the A stamper is disposed on a first upper base with a surface thereof formed with the A concave/convex pattern facing downward, whereafter the first upper base is caused to approach relative to the first lower base, to thereby attach the A stamper to the one surface of the substrate, a B stamper attaching process in which the A stamper is disposed on a second lower base with the other surface of the substrate having the A stamper attached thereto facing upward, and the B stamper is disposed on a second upper base with a surface thereof formed with the B concave/convex pattern facing downward, whereafter the second upper base is caused to approach relative to the second lower base, to thereby attach the B stamper to the other surface of the substrate, and a pressing process that presses a laminate of the A stamper, the substrate, and the B stamper by using a pressing device having a third lower base and a third upper base, to thereby form the C concave/convex pattern and the D concave/convex pattern on the substrate are carried out in the mentioned order.

5. The imprinting method according to claim 2, wherein an A stamper attaching process in which the substrate is disposed on a first lower base with the one surface thereof facing upward, and the A stamper is disposed on a first upper base with a surface thereof formed with the A concave/convex pattern facing downward, whereafter the first upper base is caused to approach relative to the first lower base, to thereby attach the A stamper to the one surface of the substrate, a B stamper attaching process in which the A stamper is disposed on a second lower base with the other surface of the substrate having the A stamper attached thereto facing upward, and the B stamper is disposed on a second upper base with a surface thereof formed with the B concave/convex pattern facing downward, whereafter the second upper base is caused to approach relative to the second lower base, to thereby attach the B stamper to the other surface of the substrate, and a pressing process that presses a laminate of the A stamper, the substrate, and the B stamper by using a pressing device having a third lower base and a third upper base, to thereby form the C concave/convex pattern and the D concave/convex pattern on the substrate are carried out in the mentioned order.

6. The imprinting method according to claim 3, wherein an A stamper attaching process in which the substrate is disposed on a first lower base with the one surface thereof facing upward, and the A stamper is disposed on a first upper base with a surface thereof formed with the A concave/convex pattern facing downward, whereafter the first upper base is caused to approach relative to the first lower base, to thereby attach the A stamper to the one surface of the substrate, a B stamper attaching process in which the A stamper is disposed on a second lower base with the other surface of the substrate having the A stamper attached thereto facing upward, and the B stamper is disposed on a second upper base with a surface thereof formed with the B concave/convex pattern facing downward, whereafter the second upper base is caused to approach relative to the second lower base, to thereby attach the B stamper to the other surface of the substrate, and a pressing process that presses a laminate of the A stamper, the substrate, and the B stamper by using a pressing device having a third lower base and a third upper base, to thereby form the C concave/convex pattern and the D concave/convex pattern on the substrate are carried out in the mentioned order.

7. A method of manufacturing an information recording medium, wherein the C concave/convex pattern is formed on the one surface of the substrate, and the D concave/convex pattern is formed on the other surface of the substrate, according to the imprinting method according to claim 1, and an information recording medium is manufactured using the formed C concave/convex pattern and the formed D concave/convex pattern.

8. A method of manufacturing an information recording medium, wherein the C concave/convex pattern is formed on the one surface of the substrate, and the D concave/convex pattern is formed on the other surface of the substrate, according to the imprinting method according to claim 2, and an information recording medium is manufactured using the formed C concave/convex pattern and the formed D concave/convex pattern.

9. A method of manufacturing an information recording medium, wherein the C concave/convex pattern is formed on the one surface of the substrate, and the D concave/convex pattern is formed on the other surface of the substrate, according to the imprinting method according to claim 3, and an information recording medium is manufactured using the formed C concave/convex pattern and the formed D concave/convex pattern.

10. An imprinting system which is configured to be capable of forming the C concave/convex pattern on the one surface of the substrate, and forming the D concave/convex pattern on the other surface of the substrate, according to the imprinting method according to claim 1.

11. An imprinting system which is configured to be capable of forming the C concave/convex pattern on the one surface of the substrate, and forming the D concave/convex pattern on the other surface of the substrate, according to the imprinting method according to claim 2.

12. An imprinting system which is configured to be capable of forming the C concave/convex pattern on the one surface of the substrate, and forming the D concave/convex pattern on the other surface of the substrate, according to the imprinting method according to claim 3.

13. The imprinting system according to claim 10, comprising an A stamper attaching device which includes a first lower base on which the substrate can be disposed with the one surface thereof facing upward, and a first upper base on which the A stamper can be disposed with a surface thereof formed with the A concave/convex pattern facing downward, and is configured to be capable of attaching the A stamper to the one surface of the substrate by causing the first upper base to approach relative to the first lower base, a B stamper attaching device which includes a second lower base on which the A stamper can be disposed with the other surface of the substrate having the A stamper attached thereto facing upward, and a second upper base on which the B stamper can be disposed with a surface thereof formed with the B concave/convex pattern facing downward, and is configured to be capable of attaching the B stamper to the other surface of the substrate by causing the second upper base to approach relative to the second lower base, and a pressing device which includes a third lower base and a third upper base, and presses a laminate of the A stamper, the substrate, and the B stamper to thereby form the C concave/convex pattern and the D concave/convex pattern on the substrate.

14. The imprinting system according to claim 11, comprising an A stamper attaching device which includes a first lower base on which the substrate can be disposed with the one surface thereof facing upward, and a first upper base on which the A stamper can be disposed with a surface thereof formed with the A concave/convex pattern facing downward, and is configured to be capable of attaching the A stamper to the one surface of the substrate by causing the first upper base to approach relative to the first lower base, a B stamper attaching device which includes a second lower base on which the A stamper can be disposed with the other surface of the substrate having the A stamper attached thereto facing upward, and a second upper base on which the B stamper can be disposed with a surface thereof formed with the B concave/convex pattern facing downward, and is configured to be capable of attaching the B stamper to the other surface of the substrate by causing the second upper base to approach relative to the second lower base, and a pressing device which includes a third lower base and a third upper base, and presses a laminate of the A stamper, the substrate, and the B stamper to thereby form the C concave/convex pattern and the D concave/convex pattern on the substrate.

15. The imprinting system according to claim 12, comprising an A stamper attaching device which includes a first lower base on which the substrate can be disposed with the one surface thereof facing upward, and a first upper base on which the A stamper can be disposed with a surface thereof formed with the A concave/convex pattern facing downward, and is configured to be capable of attaching the A stamper to the one surface of the substrate by causing the first upper base to approach relative to the first lower base, a B stamper attaching device which includes a second lower base on which the A stamper can be disposed with the other surface of the substrate having the A stamper attached thereto facing upward, and a second upper base on which the B stamper can be disposed with a surface thereof formed with the B concave/convex pattern facing downward, and is configured to be capable of attaching the B stamper to the other surface of the substrate by causing the second upper base to approach relative to the second lower base, and a pressing device which includes a third lower base and a third upper base, and presses a laminate of the A stamper, the substrate, and the B stamper to thereby form the C concave/convex pattern and the D concave/convex pattern on the substrate.
